(19) United States
(12) Patent Application Publication
(10) Pub. No.: US 2020/0126003 A1
(43) Pub. Date: Apr. 23, 2020

(54) COLLECTIVE GROUP OF HOTEL ROOMS ABLE TO BE SELECTIVELY AND SERIALLY LINKED BY A CUSTOMER

(71) Applicant: Hilton International Holding LLC, McLean, VA (US)

(72) Inventors: Robert Kenneth McLaughlin, III, Herndon, VA (US); Barton Lee May, Germantown, TN (US); Laura Kathleen Millican, Munford, TN (US); Shreya Shah Cralle, Falls Church, VA (US); Emily Lynn Silberstein, Bethesda, MD (US); Philip Keith Cordell, Fort Lauderdale, FL (US)

(21) Appl. No.: 16/660,753

(22) Filed: Oct. 22, 2019

Related U.S. Application Data
(60) Provisional application No. 62/748,862, filed on Oct. 22, 2018.

(51) Int. Cl. G06Q 10/02; G06Q 50/12

(52) U.S. Cl. CPC G06Q 10/02; G06Q 50/12

(57) ABSTRACT

Provided is a collective group of hotel rooms comprised of individual rooms, each with distinctly compact layouts, able to be selectively configured and serially linked by a customer at booking so as to uniquely and efficiently satisfy the specific needs of customers traveling in groups of any size. Affording customers the flexibility to selectively link the type and number of rooms at booking effectively eliminates the inefficiencies associated with large groups or travelers with unique spatial needs seeking accommodation in a hotel. Various embodiments are directed to a hospitality systems and methods for receiving a reservation request associated with a collective group of linked hotel rooms and accommodate the reservation request by booking a linked room combination associated therewith.

### CROSS-REFERENCE TO RELATED APPLICATIONS

This patent application claims priority from provisional Patent Application Ser. No. 62/748,862, filed Oct. 22, 2018, which is incorporated herein by reference in its entirety.

### BACKGROUND

A hotel is, at its most basic, a building that provides temporary lodging for a customer or group of customers in exchange for a nightly fee. A critical component of the tourism industry, hotels are frequented by customers traveling in groups of varying sizes, for business or for pleasure, who need a temporary lodging arrangement solely for the duration of their trip. These trips often lead customers to immensely popular urban cities, where real estate is in high demand and square footage comes at a premium price. This has driven hotels in such urban environments to decrease the area of the individual rooms in order to maximize the number of rooms available and the number of customers the hotel can service on any given night.

This practice has inherently led to problems for customers traveling in groups, whose spatial needs do not fit efficiently within the structural confines of modern hotels. While customers traveling in groups have the ability to book a multitude of rooms, booking separate rooms can be less cost effective, and the close-knit, collective atmosphere that often accompanies traveling in a group is effectively lost. Some hotels may offer two distinct rooms that are able to be conjoined by a single doorway, but for large groups that are unable to effectively fit in two rooms, there is no alternative to paying for individual rooms and staying separately. Further, in such a circumstance, a problematic scenario may arise wherein a group is comprised of a number of customers that are able to fill a number of rooms, but has a remainder customer(s) who is left occupying rooms that are not completely full. Undesirably, this arrangement, wherein some group members stay in a fully occupied room while a remaining portion of the group is forced to reside in a room at less than capacity, leads to either an inefficient or an uneven distribution of payment amongst the group. The present issues of minimization and inflexibility of hotel room configuration are only exacerbated when a customer or group of customers require a designated space within the room(s) to be utilized for some space-consuming activity other than sleeping (e.g., working in a collaborative environment, lounging with a group of friends, entertaining a guest, etc.). Accordingly, there is a need for a hotel room configuration that exists in a compact environment where space is at a premium, yet efficiently and effectively caters to the unique needs of large groups or those utilizing the room for other space-consuming activities.

Further, while there are presently hospitality enterprises that allow for a guest to make a reservation for two adjacent rooms that may be linked by a central doorway, there is not presently a system that can conduct the booking of such a reservation automatically at substantially the same time as the reservation request is received by the system. Due in part to the desire by hotel management to maximize hotel occupancy and efficiency issues presented by allowing guests to book more than one adjacent room at a time, hotels presently caveat a guest's request for a pair of linked rooms with a disclaimer that fulfillment of such a request is not guaranteed and may be determined based on an ad-hoc search of the available room inventory at a guest's designated check-in time to determine whether two adjacent linked rooms are available for the duration of the guest's reservation. At check-in, if there are still two adjacent rooms that may be linked via a central doorway, the hotel may accommodate the guest's request for a pair of linked rooms via a manual process whereby a hotel employee will manually assign each of the respective rooms as being part of the guest's reservation. In this respect, the hospitality industry is hindered by the inability to actually reserve at booking a plurality of linkable rooms, as guests who requested a plurality of distinctly identified rooms in a linked room configuration are frequently informed at check-in that the hotel cannot accommodate their request, and the manual nature of the present connected rooms reservation process makes it difficult to effectively characterize the supply of available linkable rooms for a given date in the future. Accordingly, there is a need for a hospitality system that can effectively and efficiently accommodate a reservation request for a group of rooms that may be linked together via an automated process. Further, there is a need for a hospitality system that can effectively and efficiently reserve, via an automated process, two or three or more linkable rooms that may be serially linked together upon receiving a corresponding reservation request.

Embodiments of the present invention relate to hotel rooms, and more particularly, to a collective group of hotel rooms comprised of individual rooms, each with distinctly compact layouts, able to be selectively configured and serially linked by a customer at booking so as to uniquely and efficiently satisfy the specific needs of customers traveling in groups of any size. While each room has the capability of being fully functional independent of other rooms (i.e. comprising a bed, desk, sink, shower, toilet, and wardrobe compartment), the selectively linkable configurations create unique combinations of distinct room layouts that, in tandem, more efficiently facilitate the needs of those traveling in groups or needing additional space.

Further, embodiments of the present invention relate to a hospitality system and associated methods for accommodating a reservation request associated with a collective group of hotel rooms able to be selectively and/or serially linked in an automated manner, as described herein.

### BRIEF DESCRIPTION OF THE SEVERAL VIEWS OF THE DRAWINGS

Having thus described the invention in general terms, reference will now be made to the accompanying drawings, which are not necessarily drawn to scale, wherein:

FIG. 1 is a depiction of a top view perspective of a Standard Room;

FIG. 2 depicts a schematic drawing of the floor plan of the Standard Room;

FIG. 3 depicts a schematic drawing of the floor plan of a Corner Room;

FIG. 4 depicts a schematic drawing of the floor plan of a Flex Room with the bed in the raised position;

FIG. 5 depicts a schematic drawing of the floor plan of the Flex Room with the bed in the lowered position;

FIG. 6 is an image of a first-person perspective view of the Flex Room, wherein the bed in a raised configuration;

FIG. 7 is an image of a first-person perspective view of the Flex Room, wherein the bed is in a lowered configuration;

FIG. 8 depicts a schematic drawing of the floor plan of a Bunk Room;

FIG. 9 is an image of a first-person perspective view of the Bunk Room;

FIG. 10 is an image of a perspective view of the exterior of a plurality of rooms in a selectively linked configuration;

FIG. 11 is an image of a first-person perspective view along the linked corridor of a plurality of rooms in a selectively linked configuration;

FIG. 12 illustrates a schematic view of a system encompassing a group-based communication system in communication with one or more client devices in accordance with one embodiment;

FIG. 13 illustrates an apparatus of a group-based communication server(s) in accordance with one embodiment;

FIGS. 14A-14C illustrate a lane diagram showing functionality of various components in accordance with various embodiments;

FIG. 15 is a flowchart illustrating example steps for accommodating a reservation request comprising a split payment request in accordance with various embodiments;

FIG. 16 illustrates a schematic drawing of the floor plan of a potential combination of rooms in a selectively linked configuration;

FIG. 17 illustrates a schematic drawing of the floor plan of a potential combination of rooms in a selectively linked configuration;

FIG. 18 illustrates a schematic drawing of the floor plan of a potential combination of rooms in a selectively linked configuration;

FIG. 19 illustrates a schematic drawing of the floor plan of a potential combination of rooms in a selectively linked configuration;

FIG. 20 is an image of a top view of a block of proximate rooms; and

FIG. 21 depicts a cutaway view of a potential combination of rooms in a selectively linked configuration.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is generally directed to a collective group of hotel rooms comprised of individual rooms, each with distinctly compact layouts, able to be selectively configured and serially linked by a customer at booking so as to uniquely and efficiently satisfy the specific needs of customers traveling in groups of any size. Further accommodating groups of all shapes and sizes, embodiments of the present invention will allow guests to split payments between more than one person at the time of booking.

Further, the present invention is directed to a hospitality system and associated methods for accommodating a reservation request associated with a collective group of hotel rooms able to be selectively and/or serially linked based in part on the reservation request, the system comprising an automated system that reserves the group of hotel rooms able to be selectively and/or serially linked as a single linked room combination at, or at least substantially soon thereafter, the time of booking, as described herein.

### Exemplary Room Configurations

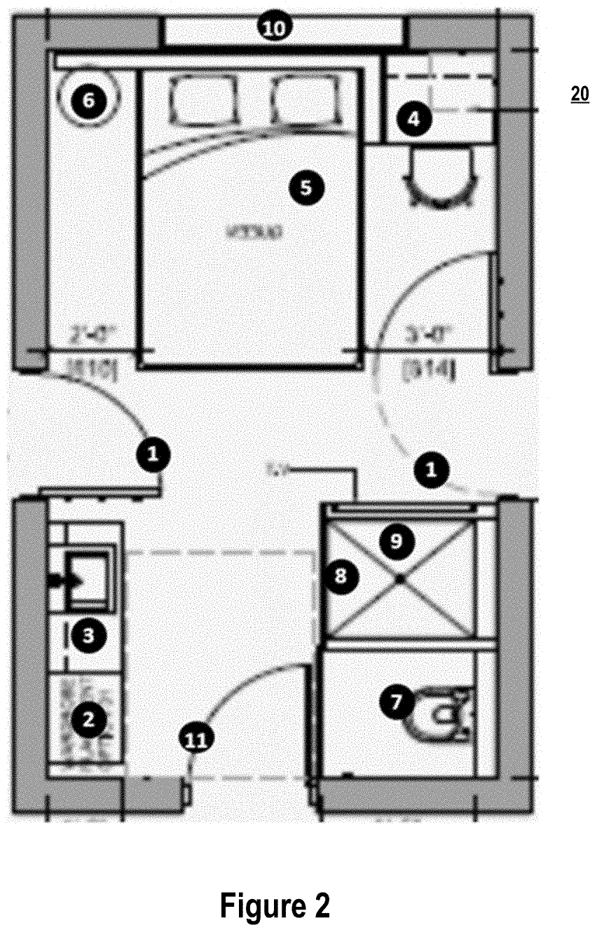

Collectively, embodiments of the present invention comprises four distinct room layouts: the Standard Room, the Corner Room, the Flex Room, and the Bunk Room. As described herein, each of the different room layouts may have a corresponding room type identifier, which may be associated with a room identifier so as to indicate that the room associated with the room identifier comprises the room type (i.e. layout) corresponding to the room type identifier. In various embodiments, for example, at booking or at some time thereafter, a customer can select the specific combination of proximate rooms that he or she wishes. Because the rooms have different capacities and different customizable features that facilitate different activities, a customer has the ability to choose the specific combination of rooms that most efficiently and effectively accommodates his or her particular group or specialized use. Uniquely, a customer has the flexibility to book three or more distinct rooms and have them all selectively linked so as to create a single linked corridor that runs continuously through the entirety of the customer's plurality of linked rooms. Notably, each of these room layouts can be fully functional independent of other potentially linked rooms. As shown in FIGS. 2, 3, 4, and 7, each of the respective room layouts can come equipped with basic accommodation elements, including, but not limited to, a bed 5, a wardrobe compartment 2, an integrated vanity/sink 3, a desk 4, a toilet 7, a stand-alone shower 8, and a window 10. Although described with regards to four distinct available room layouts, any combination of the room layouts or multiples of the room layouts could be configured to create a set of two, three, five, six, or more selectively linked rooms. The present invention is not limited to such exemplary embodiments and further contemplates a plurality of rooms comprising individual room layouts of any configuration and any given name, or all possible variations thereof. In some embodiments, the square footage of the disclosed room is 200 square feet or less. In some embodiments the square footage of the disclosed room is 175 square feet or less. In some embodiments the square footage of the disclosed room is 163 square feet or less. In some embodiments the square footage of the disclosed room is 150 square feet or less.

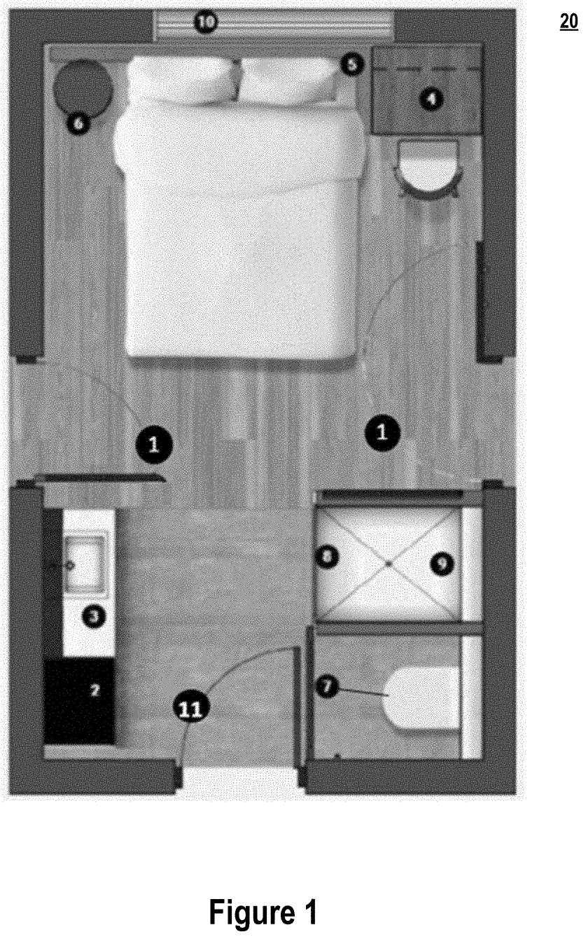

As shown in FIGS. 1 and 2, one aspect of the Standard Room layout 20 comprises a basic hotel room configuration complete with each of the aforementioned basic elements that would allow this room to be suitable for a single-room accommodation as well as two linking doors 1 on both ends of the room to accommodate a guest's preferred linked configuration. This embodiment of the Standard Room 20 can comfortably sleep two guests while featuring an enlarged desk 4 and a stand-alone side table 6.

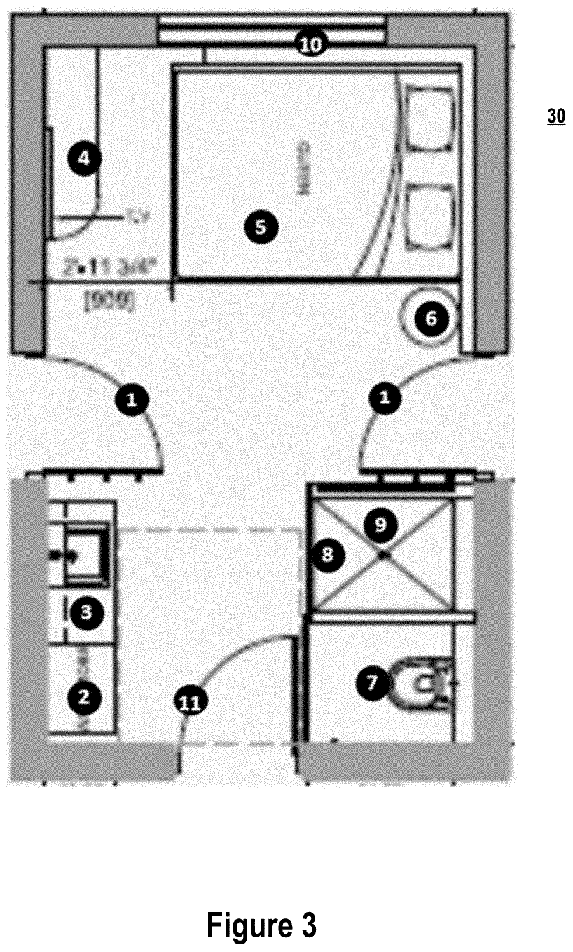

As shown in FIG. 3, one aspect of the Corner Room layout 30 comprises a hotel room configuration complete with each of the aforementioned basic elements that would allow this room to be suitable for a single-room accommodation, as well as two linking doors 1 on both ends of the room to accommodate a guest's preferred linked configuration. Distinct from the Standard Room 20, this embodiment of the Corner Room 30 has an elongated desk 4 and a bed 5 that is arranged in the corner of the room—thereby providing an increased interior hall space. The Corner Room 30 can comfortably sleep two guests and features a stand-alone side table 6.

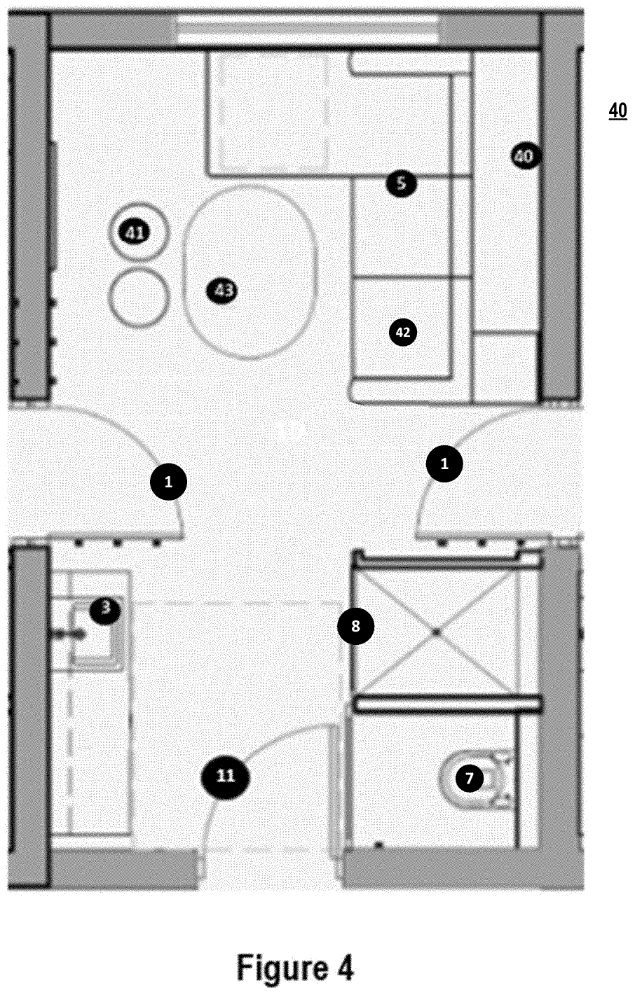

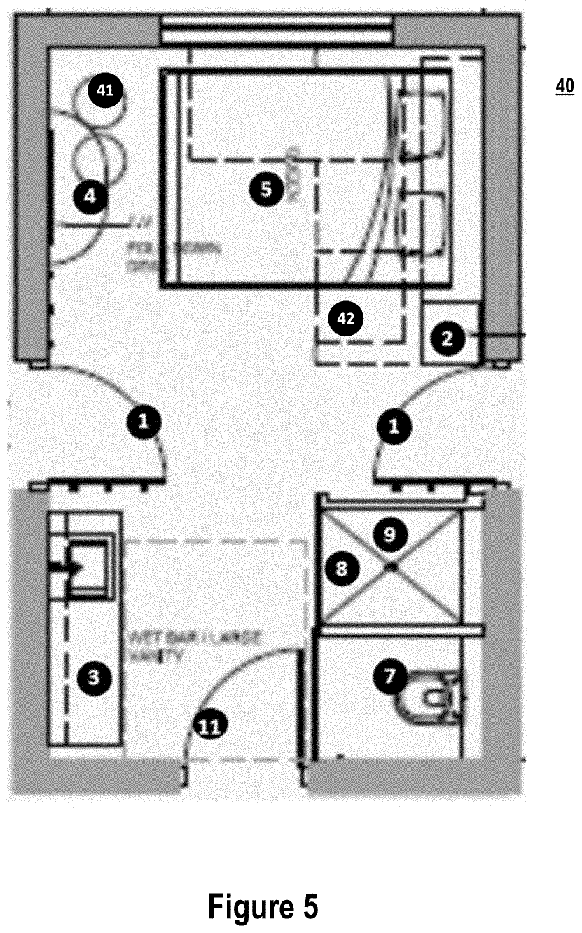

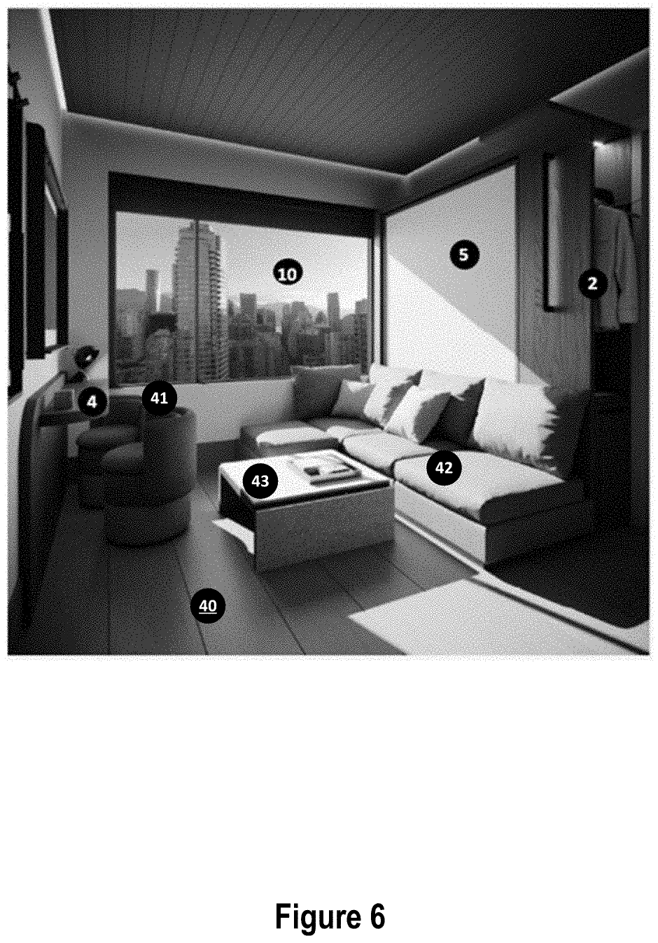

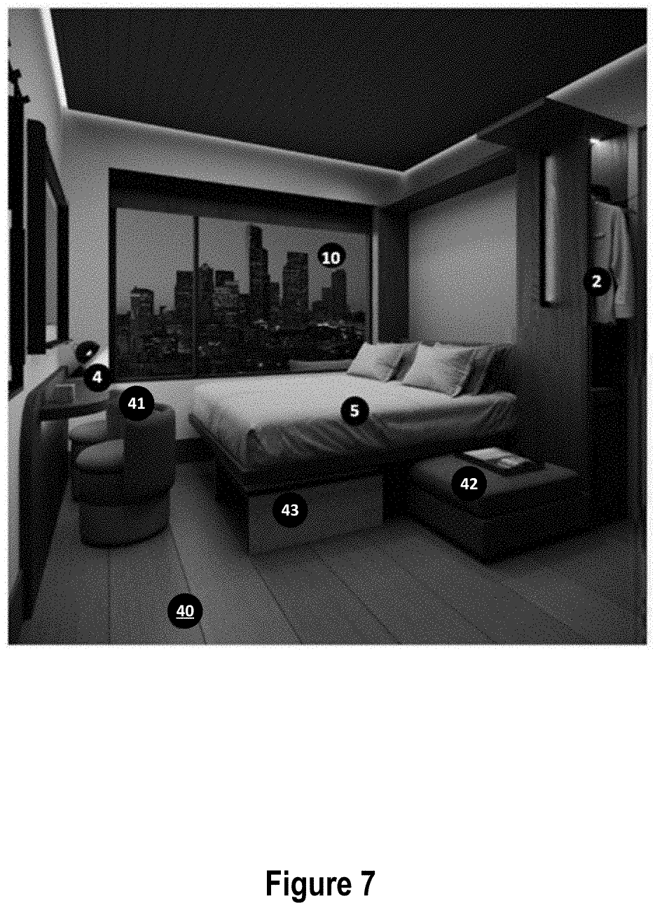

As shown in FIGS. 4-7, one aspect of the Flex Room layout 40 comprises a hotel room configuration complete with each of the aforementioned basic elements that would allow this room to be suitable for a single-room accommodation as well as two linking doors 1 on both ends of the room to accommodate a guest's preferred linked configuration. Distinct from both the Standard Room 20 and the Corner Room 30, this embodiment of the Flex Room 40 has a space-saving desk 4 and a bed 5 that may be lowered into a sleeping position, or folded about a pivot point into a raised position against a wall (i.e. a “wall” bed). Further, the illustrated embodiment of the Flex room comprises an elongated vanity/wet bar 3 and additional seating 41, a sofa 42, and a coffee table 43 to accommodate a more social setting. FIG. 6 depicts an aspect of the Flex Room layout 40 wherein the bed 5 is arranged in a raised position so as to maximize floor space and further facilitate social interaction amongst a group of guests. In such a configuration, the back cushions of the sofa 42 may be arranged so as to rest against the wall created by the raised bed 5. Conversely, FIG. 7 depicts an aspect of the Flex Room layout 40 wherein the bed 5 is lowered in a sleeping position that can comfortably sleep two guests. In such a configuration, the bed 5 may be lowered to rest upon the coffee table 43 and the back cushions of the sofa may be selectively stored within a storage compartment located underneath the front cushions of the sofa 42 or elsewhere in the room.

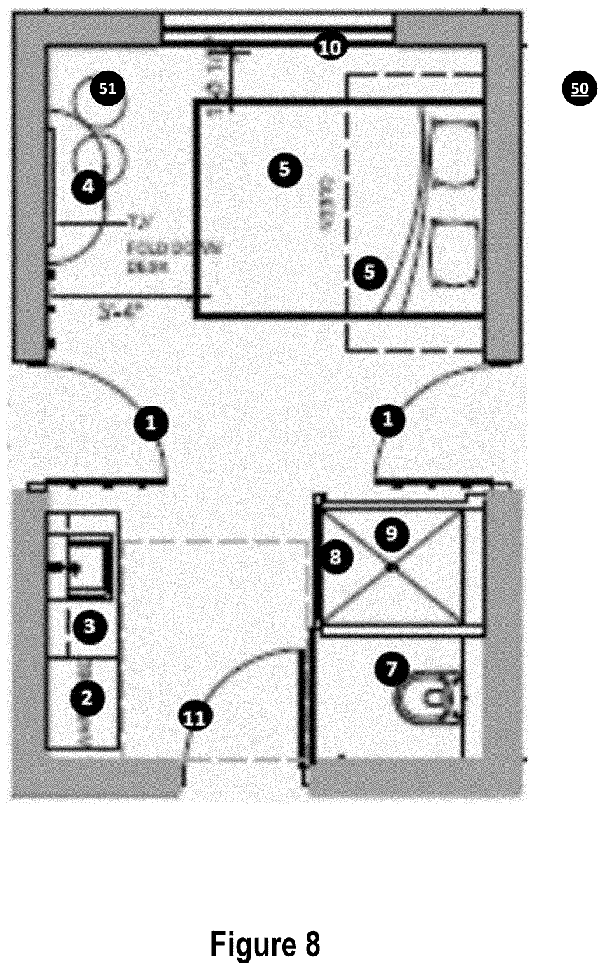

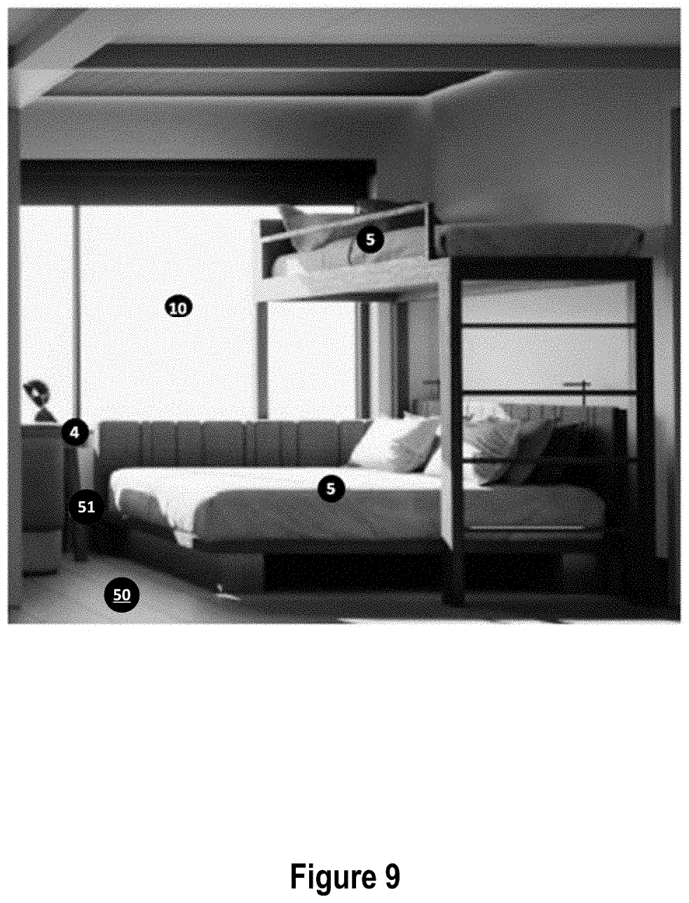

As shown in FIGS. 8 and 9, one aspect of the Bunk Room layout 50 comprises a hotel room configuration complete with each of the aforementioned basic elements that would allow this room to be suitable for a single-room accommodation as well as two linking doors 1 on both ends of the room to accommodate a guest's preferred linked configuration. Like the Flex Room layout 40, the Bunk Room layout 50 comprises a space-saving desk 4, as well as additional seating 51. Distinct from any of the other three-room layouts, however, the illustrated Bunk Room layout 50 can comfortably sleep three guests, as it is equipped with a bed 5 in a two-tiered configuration (i.e. a bunk bed) meant to maximize sleeping capacity while minimizing its footprint in the room.

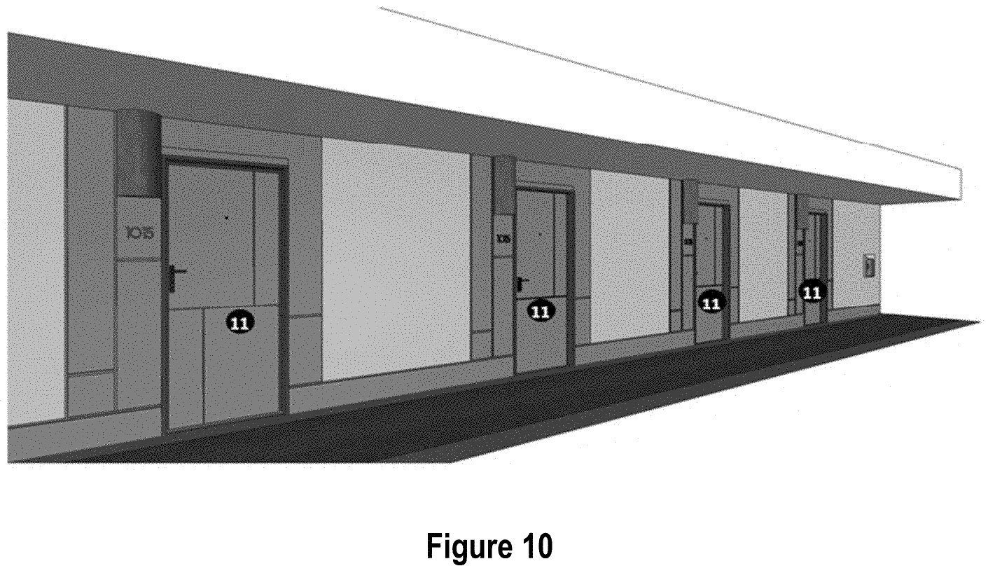

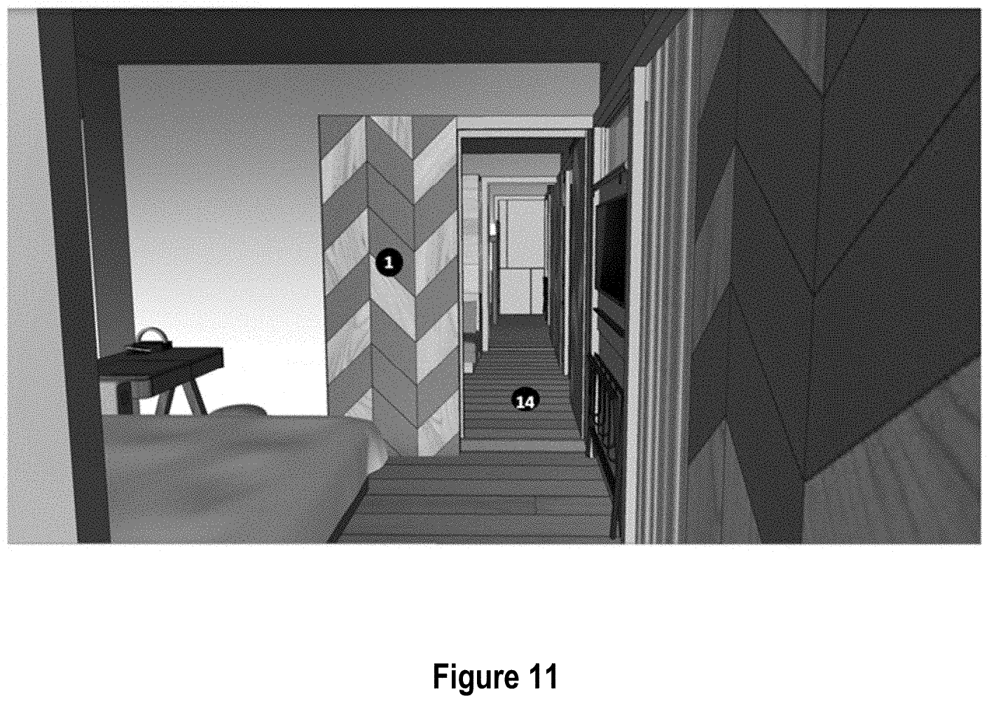

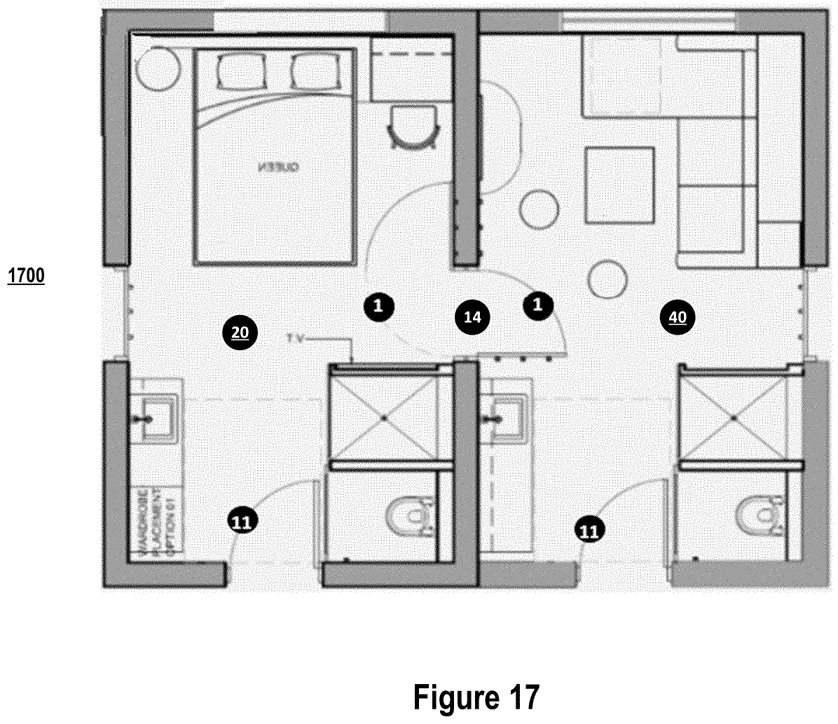

As discussed in further detail herein, a plurality of rooms of a hotel may be serially linked via a single reservation. A hospitality system, as described herein, may accommodate a guest's reservation request for a linked room combination comprising a plurality of linked rooms (e.g., two, three, four, six). The plurality of linked rooms may comprise two or more linked rooms, which may define any combination of different (or the same) room types. For example, FIGS. 10 and 11 illustrate various aspects of rooms in a selectively linked configuration. FIG. 10 is a perspective view of the exterior of a block of proximate rooms. While each of these rooms may be selectively and serially linked by a customer at booking, the exterior of the rooms can retain the same optical appearance, with each room having a respective front door 11. The presence of a selectively linked configuration of rooms cannot be determined from the exterior of the rooms. Further, as shown in the perspective view of FIG. 17, when a guest reserves a particular linked room combination and chooses to selectively and/or serially link multiple rooms, each of the respective linking doors 1 may be in an open configuration so as to create a single linked corridor 14 that runs continuously through at least a portion (e.g., the entirety) of the guest's plurality of rooms. Although not shown, in some embodiments the internal corridor may comprise distinct walls that define the length, or at least part of the length, of the connection of two adjacent linked rooms.

While embodiments herein describe self-booking, example embodiments might also include booking through a hotel employee or an algorithm-based reservation system, wherein the hotel employee or reservation system could select a specific combination of proximate rooms based on a customer's input describing their unique travel. Further, although described with regards to four distinct available room layouts, any combination of the room layouts or multiples of the room layouts could be configured to create a set of three, five, six, or more selectively linked rooms.

### System for Reserving a Plurality of Rooms as Linked Room Combination

Various embodiments described herein are directed to a hospitality system and associated methods for accommodating a reservation request associated with a collective group of hotel rooms able to be selectively and serially linked, as described herein.

i. Exemplary System Architecture

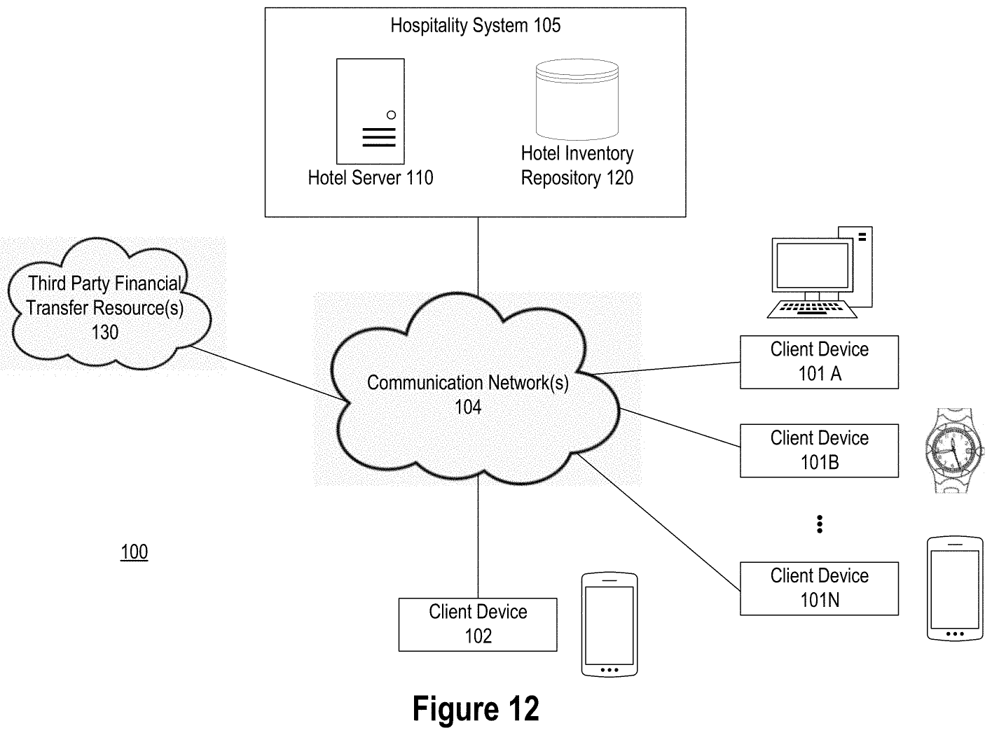

FIG. 12 provides an example computing system 100 that can be used in conjunction with various embodiments of the present invention. As shown in FIG. 1, the example computing system 100 may comprise a hospitality system 105 comprising a hotel server 110 and a hotel inventory repository 120. In various embodiments, the hospitality system 105 may communicate with other elements of the computing system 100, such as, for example, at least one client device 101A-101N, 102, a third party financial transfer resource 130, and/or the like. Each of the components of the system may be in electronic communication with, for example, one another over the same or different wireless or wired networks 104 including, for example, a wired or wireless Personal Area Network (PAN), Local Area Network (LAN), Metropolitan Area Network (MAN), Wide Area Network (WAN), and/or the like. For example, in various embodiments, the one or more communication networks 104 described herein may use any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. Additionally, while FIG. 12 illustrates certain system entities as separate, standalone entities, the various embodiments are not limited to this particular architecture.

As described herein, the term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

ii. Example Apparatuses Utilized with Various Embodiments

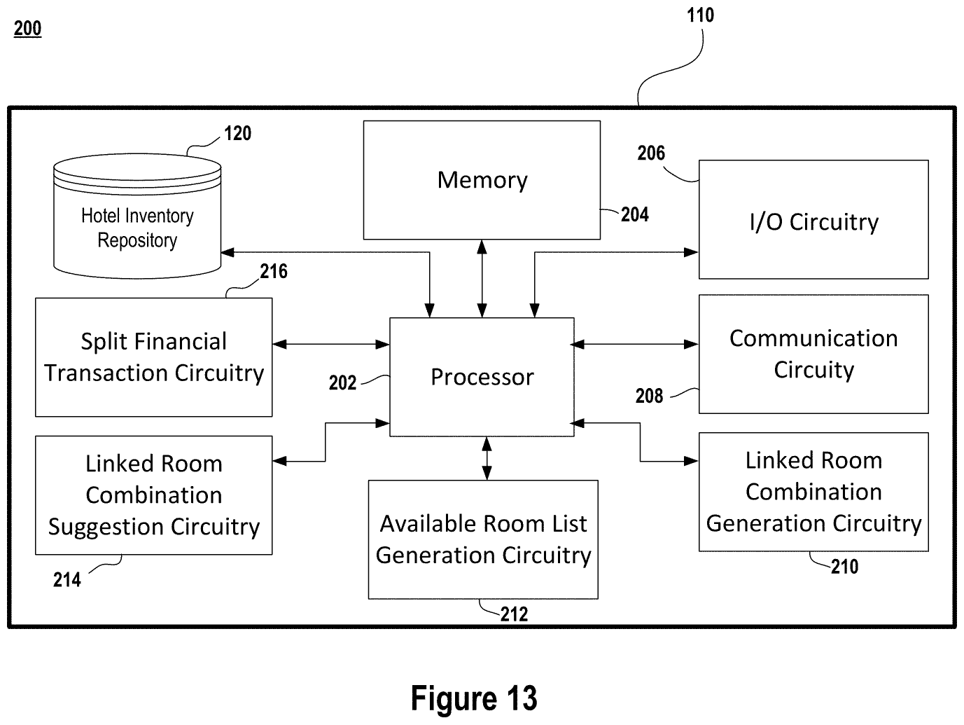

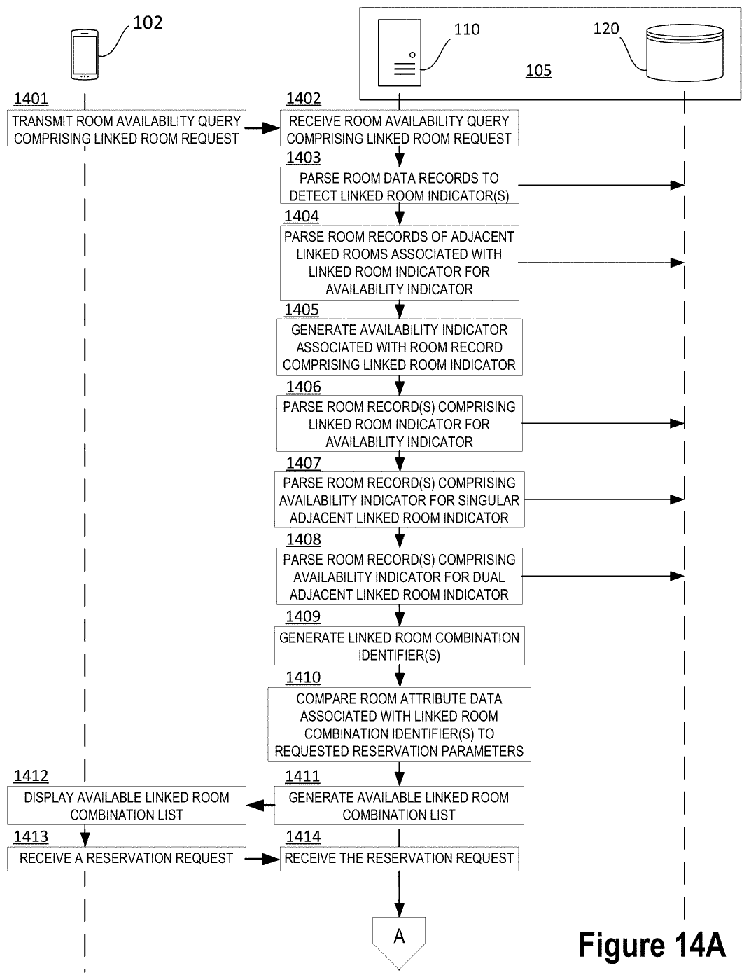

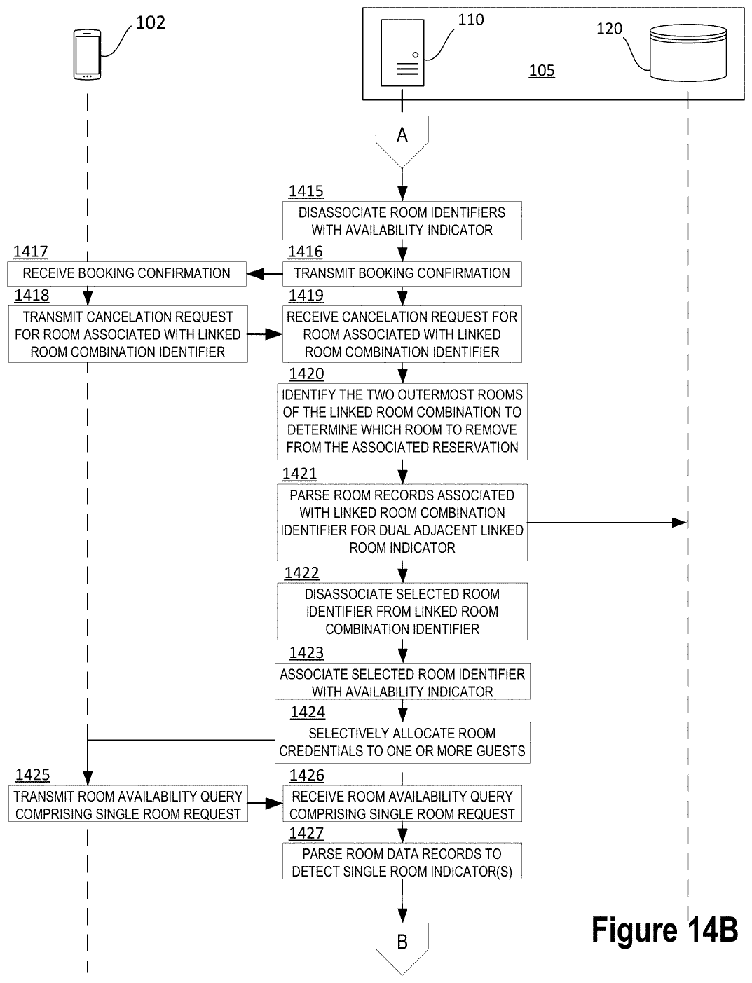

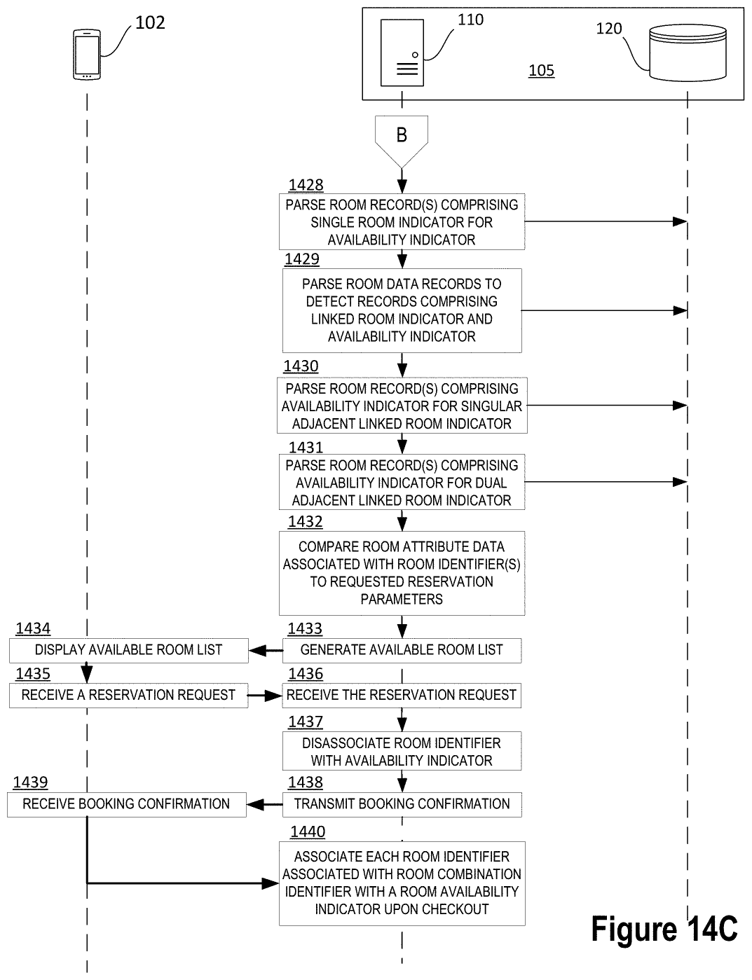

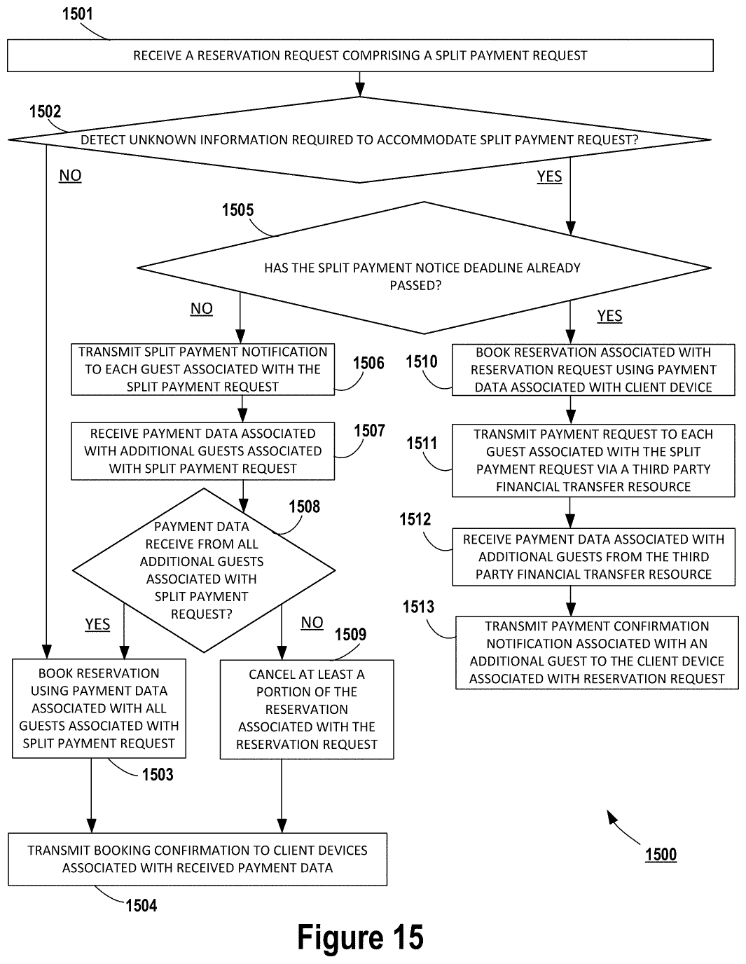

Each hotel server(s) 110 may be embodied by one or more computing systems, such as apparatus 200 shown in FIG. 13. The apparatus 200 may include processor 202, memory 204, input/output circuitry 206, communications circuitry 208, linked room combination generation circuitry 210, available room generation list circuitry 212, linked room combination suggestion circuitry 214, and split financial transaction circuitry 216. The apparatus 200 may be configured to execute the operations described herein with respect to FIGS. 14A-15. Although these components 202-216 are described with respect to functional limitations, it should be understood that the particular implementations necessarily include the use of particular hardware. It should also be understood that certain of these components 202-216 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 may be non-transitory and may include, for example, one or more volatile and/or non-volatile memories. For example, the memory 204 may be an electronic storage device (e.g., a computer readable storage medium). In various embodiments, the memory 204 may be configured to store information, data, content, applications, instructions, or the like, for enabling the apparatus to carry out various functions in accordance with example embodiments of the present disclosure. It will be understood that the memory 204 may be configured to store partially or wholly any electronic information, data, computer program products described herein, or any combination thereof.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Alternatively, or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output circuitry 206 that may, in turn, be in communication with processor 202 to provide output to a user and, in some embodiments, to receive an indication of a user input. The input/output circuitry 206 may comprise a user interface and may include a display, and may comprise a web user interface, a mobile application, a client device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communication circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communication circuitry 208 may include, for example, a network interface for enabling communications with a wired or wireless communication network. For example, the communication circuitry 208 may include one or more network interface cards, antennae, buses, switches, routers, modems, and supporting hardware and/or software, or any other device suitable for enabling communications via a network. Additionally or alternatively, the communication circuitry 208 may include the circuitry for interacting with the antenna/antennae to cause transmission of signals via the antenna/antennae or to handle receipt of signals received via the antenna/antennae.

Linked room combination generation circuitry 210 may be a device or circuitry embodied in either hardware or a combination of hardware and software that is configured to generate at least one linked room combination identifier associated with a linked room combination comprising a plurality of linked rooms, as described herein. The linked room combination generation circuitry 210 may utilize processing circuitry, such as the processor 202, to perform these actions. For example, the linked room combination generation circuitry 210 may be configured to associate the generated linked room combination identifier with each of the room identifiers associated with a room of the plurality of linked rooms which define the linked room combination associated therewith. Further, in various embodiments, the linked room combination generation circuitry 210 may be configured to generate an available linked room combination list at least in part by comparing at least a portion of the room attribute data associated, respectively, with each room identifier associated with the plurality of linked rooms of a linked room combination to one or more of the plurality of requested reservation parameters received as inputs to the hospitality system 105, as described herein. The linked room combination generation circuitry 210 may send and/or receive data from hotel inventory repository 120. It should also be appreciated that, in some embodiments, the linked room combination generation circuitry 210 may include a separate processor, specially configured field programmable gate array (FPGA), or application specific interface circuit (ASIC). The linked room combination generation circuitry 210 may be implemented using hardware components of the apparatus 200 configured by either hardware or software for implementing these planned functions.

Available room generation list circuitry 212 may be a device or circuitry embodied in either hardware or a combination of hardware and software that is configured to generate either an available room list or an available linked room combination list based at least in part on a room availability query received by the apparatus 200 that comprises either a single room request or a linked room request, as described herein. The available room generation list circuitry 212 may utilize processing circuitry, such as the processor 202, to perform these actions. For example, the available room generation list circuitry 212 may be configured to determine, based at least in part on a comparison between at least a portion of the room attribute data associated, respectively, with each room identifier associated with a plurality of linked rooms of a linked room combination to one or more of the plurality of requested reservation parameters defining a room availability query, which linked room combination identifiers to include in a generated available linked room combination list. Further, in various embodiments, the available room generation list circuitry 212 may be configured to display only a subset of available rooms and/or linked room combinations based on one or more executable instructions corresponding to a relative booking priority order, as described herein. The available room generation list circuitry 212 may send and/or receive data from hotel inventory repository 120. It should also be appreciated that, in some embodiments, the available room generation list circuitry 212 may include a separate processor, specially configured field programmable gate array (FPGA), or application specific interface circuit (ASIC). The available room generation list circuitry 212 may be implemented using hardware components of the apparatus 200 configured by either hardware or software for implementing these planned functions.

Linked room combination suggestion circuitry 214 may be a device or circuitry embodied in either hardware or a combination of hardware and software that is configured to determine one or more linked room combinations to be suggested to user based on at least one requested reservation parameters. The linked room combination suggestion circuitry 214 may utilize processing circuitry, such as the processor 202, to perform these actions. For example, the linked room combination suggestion circuitry 214 may be configured to surface a suggested linked room combination identifier to be included in an available linked room combination list in response to a room availability query in which one of the plurality of requested reservation parameters is a requested guest count. Further, in various embodiments, the linked room combination suggestion circuitry 214 may be configured to, upon a determination by the apparatus 200 that there is no available linked room combination which satisfies each of a plurality of requested reservation parameters, surface a suggested linked room combination identifier associated with a room availability indicator and various room attribute data similar to that of a linked room combination identifier which would satisfy each of the requested reservation parameters. For example, in various embodiments, the linked room combination suggestion circuitry 214 may be a wizard configured to generate a suggested linked room combination based at least in part on user input. The linked room combination suggestion circuitry 214 may send and/or receive data from hotel inventory repository 120. It should also be appreciated that, in some embodiments, the linked room combination suggestion circuitry 214 may include a separate processor, specially configured field programmable gate array (FPGA), or application specific interface circuit (ASIC). The linked room combination suggestion circuitry 214 may be implemented using hardware components of the apparatus 200 configured by either hardware or software for implementing these planned functions.

Split financial transaction circuitry 216 may be a device or circuitry embodied in either hardware or a combination of hardware and software that is configured to facilitate the payment of a portion of a reservation price associated with a reservation of a linked room combination by a plurality of guests associated with the reservation. The split financial transaction circuitry 216 may utilize processing circuitry, such as the processor 202, to perform these actions. For example, the split financial transaction circuitry 216 may be configured to communicate with at least one third party financial transfer resource. Further, in various embodiments, the split financial transaction circuitry 216 may be configured to assign a portion of the total reservation price to a plurality of guests associated with the reservation and, prior to the first date of the reservation, determine which of the guests associated with a reservation have not paid their assigned portion of the reservation price. The split financial transaction circuitry 216 may send and/or receive data from hotel inventory repository 120. It should also be appreciated that, in some embodiments, the split financial transaction circuitry 216 may include a separate processor, specially configured field programmable gate array (FPGA), or application specific interface circuit (ASIC). The split financial transaction circuitry 216 may be implemented using hardware components of the apparatus 200 configured by either hardware or software for implementing these planned functions.

In various embodiments, the apparatus 200 may be configured with, or in communication with, a hotel inventory repository 120. The hotel inventory repository 120 may be stored, at least partially on the memory 204 of the apparatus 200. In some embodiments, the hotel inventory repository 120 may be remote from, but in connection with, the apparatus 200. The hotel inventory repository 120 may contain information, such as, for example, a room data record corresponding to each of the rooms of a hospitality enterprise (e.g., a hotel of a hospitality enterprise) comprising room attribute data, as described herein, associated with each of the room identifiers respectively associated with each of the rooms, at least one linked room combination identifiers, and/or the like. In various embodiments, the hotel inventory repository 120 may be configured to store at least one available room look up table and/or at least one occupied room look up table.

It is also noted that all or some of the information discussed herein can be based on data that is received, generated and/or maintained by one or more components of apparatus 200. In some embodiments, one or more application systems (such as a remote cloud computing and/or data storage system) may also be leveraged to provide at least some of the functionality discussed herein.

The term “circuitry” should be understood broadly to include hardware and, in some embodiments, software for configuring the hardware. With respect to components of each apparatus 200, the term “circuitry” as used herein should therefore be understood to include particular hardware configured to perform the functions associated with the particular circuitry as described herein. For example, in some embodiments, “circuitry” may include processing circuitry, storage media, network interfaces, input/output devices, and the like. In some embodiments, other elements of the apparatus 200 may provide or supplement the functionality of particular circuitry. For example, the processor 202 may provide processing functionality, the memory 204 may provide storage functionality, the communication circuitry 208 may provide network interface functionality, and the like.

As will be appreciated, any such computer program instructions and/or other type of code may be loaded onto a computer, processor or other programmable apparatus's circuitry to produce a machine, such that the computer, processor or other programmable circuitry that execute the code on the machine creates the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

iii. Example Hospitality System Data Flows

FIGS. 14A-14C illustrate a lane diagram showing functionality of various components associated with an exemplary hospitality system in accordance with various embodiments. As described herein, the hospitality system 105 may comprise a hotel server 110 and a hotel inventory repository 120. The exemplary hospitality system 105 may be configured to surface at least one available room option to a booking party according to one or more requested reservation parameters and book either a single room or a linked room combination based on a reservation request. In various embodiments, a client device 102 may generate a room availability query comprising a linked room request based at least in part on the user input received a user interface associated with the hotel enterprise associated with the hotel server 110, which may be transmitted to the group-based communication server 110, as shown at Blocks 1401 and 1402 in FIG. 14A. In various embodiments, the room availability query may be received from either a client device 102 or a device associated with the hospitality system 105, the device being operable by a hospitality enterprise employee. In various embodiments, a room availability query may comprise a collection of data transmitted by a client device 102 to the hotel server 110 as a result of user associated with the client device 102 indicating a desire to surface one or more available rooms of the hospitality enterprise. As described herein, a hospitality enterprise may comprise a hotel and/or a plurality of hotels (e.g., a chain of hotels), each hotel comprising one or more rooms. As described herein, each hotel of the hospitality enterprise may be associated with a hotel identifier, and each room of the hotel may be associated with a room identifier. As described herein, the term “hotel identifier” refers to one or more items of data by which a particular hotel of the hotel enterprise may be uniquely identified. Similarly, the term “room identifier” refers to one or more items of data by which a particular room of a hotel of the hotel enterprise may be uniquely identified. For example, a hotel identifier and a room identifier may each comprise ASCII text, a pointer, a memory address, and/or the like. A room identifier associated with a room may be associated with the hotel identifier associated with the hotel in which the room is located. In various embodiments, a room availability query may be associated with the client device 102 and/or a user profile associated with the user associated with the client device 102.

In various embodiments, a room availability query may be embodied as a search by the user associated with the client device 102 for one or more available rooms of the hospitality enterprise based on a plurality of requested reservation parameters. As described herein, a “requested reservation parameter” may comprise data which describes and/or defines, at least in part, one or more aspects of a room availability query, such as, for example, a plurality of room attributes by which the user associated with the room availability query wishes to filter the corresponding search for one or more available rooms. For example, a requested reservation parameter may be defined by user input, and may comprise various data associated with a length of stay (i.e. reservation data(s)), a hotel identifier, a requested room count defining a requested number of rooms, a requested guest count defining a requested number of guests, a room type identifier, a linked room request, a single room request, and/or the like. A single room request may comprise data received by the hotel server 110 as a result of a user associated with the client device 102 indicating a desire for a single room. Similarly, a linked room request may comprise data received by the hotel server 110 as a result of a user associated with the client device 102 indicating a desire to surface a plurality of rooms which may be selectively linked, as described herein. In various embodiments, a linked room request may be based on a selection by a user at a client device or may be generated by the hotel server 110 based on at least one other requested reservation parameters, such as the requested guest count, the requested room count, and the hotel identifier.

In various embodiments, a hotel server may parse a hotel inventory repository to detect at least one room data record comprising a linked room indicator, as shown at Block 1403. As described herein, a room data record may comprise a collection of individual data elements each associated with a room of a hotel enterprise that may be transmitted and/or stored within or within a plurality of computing entities collectively, such that the included data remains associated therewith. In various embodiments, a room data record may comprise a room identifier associated with the room associated therewith. For example, a room data record associated with a room may be configured to store data (e.g., room attribute data) therein with a standardized formatting, such that a computing entity (e.g., a hotel server 110) may be configured to automatically determine the type of data stored therein. For example, a room data record may comprise a plurality of room attribute data to be stored and/or retrieved by a hotel server 110, and the room data record may comprise metadata associated with the generation of the data that is stored within the room data record. For example, a room data record may comprise a plurality of room attribute data. As described herein, room attribute data may be associated with a particular room and may define one or more characteristics of a room. As non-limiting examples, room attribute data may comprise a room identifier, a hotel identifier, a room type identifier, a room capacity identifier, a room availability indicator, a single room indicator, a linked room indicator, an adjacent linked room count identifier, one or more adjacent linked room identifiers, a singular adjacent linked room indicator, a dual adjacent linked room indicator, and/or the like. In various embodiments, at least a portion of the room data records associated with each room of a hotel enterprise may be stored by the hotel inventory repository 120. As used herein, the term “indicator” refers to one or more items of data associated with one or more elements of a hospitality system 105 that indicates that a particular condition corresponding to the one or more elements associated therewith is present. In various embodiments, an indicator may comprise a textual or graphical statement generated as a representation that a given condition is present. For example, an indicator may be a data structure comprising a flag, or a record of a data structure whereby a logical “1” indicates that given condition is present and a logical “0” indicates that the given condition is not present. For example, in various embodiments, an indicator may be a linked room indicator, a single room indicator, a room availability indicator, a singular adjacent linked room indicator, and a dual adjacent linked room indicator, as determined and described herein.

Upon receiving a room availability query comprising a linked room request, a hotel server 110 may parse a hotel inventory repository 120 to detect at least one room data record comprising a linked room indicator. In various embodiments, a linked room indicator associated with a room identifier may indicate that the room associated with the linked room identifier is a linkable room such that it may be selectively linked to one or more adjacent linkable rooms. For example, the hotel server 110 may detect each room data record comprising a linked room indicator so as to identify each room of a hotel enterprise associated with the hospitality system 105 that is a linkable room.

In various embodiments, in order to determine whether a room associated with a linked room indicator is available to be linked with an adjacent linkable room on a particular date, the hotel server 110 may parse the at least one room data records associated with the each of the adjacent linked rooms associated with the one or more adjacent linked room identifiers of each of room data records comprising a linked room indicator, as shown at Block 1404. As described herein, each of the room data records comprising a linked room indicator may further comprise one or more adjacent linked room identifiers. As used herein, an “adjacent linked room identifier” may be one or more items of data by which a “linkable” room, as described herein, located adjacent to the room associated with the room data record comprising the linked room indicator may be uniquely identified. An adjacent linked room identifier may be associated with a room identifier and may comprise ASCII text, a pointer, a memory address, and/or the like. As described herein, a room data record comprising a linked room indicator may comprise either one or two adjacent linked room identifiers, depending on the physical configuration of the rooms and/or adjacent rooms associated therewith. For example, upon identifying each room data record comprising a linked room indicator, the hotel server 110 may parse each of the at least one room data records comprising a linked room indicator to detect each of the adjacent linked room identifiers associated therewith. The hotel server 110 may then parse the room data records corresponding to each of the rooms associated with the adjacent linked room identifiers to detect a room availability indicator. In various embodiments, a room availability indicator associated with a room identifier may indicate that the room associated with the room availability indicator has not been booked for a particular day(s) such that it is available to be reserved on the given date and may be presented to a user as available in certain circumstances.

In various embodiments, the hotel server 110 may determine which room data records of the at least one room data records comprising a linked room indicator have not been booked for a particular day(s) (e.g., such that they are available to be reserved on the given date and may be presented to a user as available in certain circumstances) by referencing an available room look up table stored within the hotel inventory repository 120. For example a hotel inventory repository 120 may store at least one available room look up table and at least one occupied room look up table, each being associated with a particular day(s). In various embodiments, each available room look up table comprises at least one room identifiers associated with a room that has not been booked for the particular day with which the available room look up table is associated. In various embodiments, each occupied room look up table comprises at least one room identifiers associated with a room that has been booked for the particular day with which the occupied room look up table is associated. In various embodiments, the hotel server 110 may update the one or more available room look up tables and the one or more occupied room look up tables based at least in part on reservation data received by the server 110. For example, upon booking a reservation for a room on a particular day, both the available room look up table and the occupied room look up table associated with that particular day may be updated by the hotel server, such that the room identifier associated with reserved room may be removed from the available room look up table and may be added to the occupied room look up table for the particular day.

In various embodiments, upon determining that at least one of the one or more room data records corresponding to the one or more adjacent linked room identifiers comprises a room availability indicator, the hotel server 110 may generate an availability indicator associated with the room data record comprising the linked room indicator, as shown at Block 1405, such that the room data record comprising the linked room indicator further comprises a room availability indicator. For example, a room data record that comprises a linked room indicator and a room availability indicator may indicate that the corresponding room is available as a linked room to be reserved on a given day along with at least one of the available adjacent linked rooms associated with the adjacent linked room identifiers as an available linked room combination, as described herein, in various circumstances.

As shown at Block 1406, the hotel server 110 may parse each of the room data records comprising a linked room indicator, detected as described above with respect to Block 1403, to detect at least one room data record of the room data records comprising a linked room indicator further comprising a room availability indicator. For example, the hotel server 110 may detect each room data record comprising a linked room indicator that further comprises a room availability indicator so as to identify each linkable room of a hotel enterprise associated with the hospitality system 105 that is available to be reserved in a linked room combination on a given day.

As described herein, each room data record comprising a linked room indicator may further comprise an adjacent linked room count identifier. As used herein, an “adjacent linked room count identifier” may be one or more items of data by which the number of linkable rooms (i.e. rooms corresponding to a room data records comprising a linked room indicator) located adjacent to a given linkable may be uniquely identified. An adjacent linked room count identifier may be associated with a room identifier and may comprise ASCII text, a pointer, a memory address, and/or the like. For example, an adjacent linked room count identifier may correspond to the number of adjacent linked room identifiers associated with the room data record with which the adjacent linked room count identifier is associated. In various embodiments, the adjacent linked room count identifier associated with a room identifier comprises either a singular adjacent linked room count identifier or dual adjacent linked room count identifier, based on whether the room associated with the room identifier is adjacent to one or two linked room, respectively.

In order to maximize the availability of a given number of linkable rooms that may be booked in various linked room combinations, as described herein, the hotel server 110 may be configured to prioritize those rooms associated with a singular adjacent linked room indicator over those rooms associated with a dual adjacent linked room indicator, such that linked room combinations comprising a room associated with a singular adjacent linked room indicator may be selectively surfaced to a user for reservation before a linked room combination made exclusively of rooms respectively associated with a dual adjacent linked room indicator. For example, as shown at Block 1407, the hotel server 110 may parse each of the room data records comprising both a linked room indicator and a room availability indicator, detected as described above with respect to Blocks 1403 and 1406, to detect at least one room data record of the room data records comprising both a linked room indicator and a room availability indicator that further comprises a singular adjacent linked room indicator. In various embodiments, as shown at Block 1408, the hotel server 110 may parse each of the room data records comprising both a linked room indicator and a room availability indicator to detect at least one room data record of the room data records comprising both a linked room indicator and a room availability indicator that further comprises a dual adjacent linked room indicator. For example, in various embodiments, the hotel server 110 may execute the operations described with respect to Block 1408 upon determining that there are no room data records comprising both a room availability indicator and a singular adjacent linked room indicator.

As shown at Block 1409, the hotel server 110 may generate at least one linked room combination identifier respectively associated with at least one linked room combination. As described herein, a linked room combination is a plurality of rooms, each room of the plurality being a linked room (i.e. a room associated with a room data record comprising a linked room indicator) associated with a room data record comprising a room availability indicator. Each linked room combination may be associated with a linked room combination identifier, which may be one or more items of data by which the linked room combination associated therewith may be uniquely identified. A linked room combination identifier may be associated with each of the room identifiers respectively associated with the plurality of linked rooms of the linked room combination associated therewith. In various embodiments, each of the possible linked room combinations that are available to be reserved are associated with a respective linked room combination identifier of the at least one linked room combination identifiers generated by the hotel server 110.

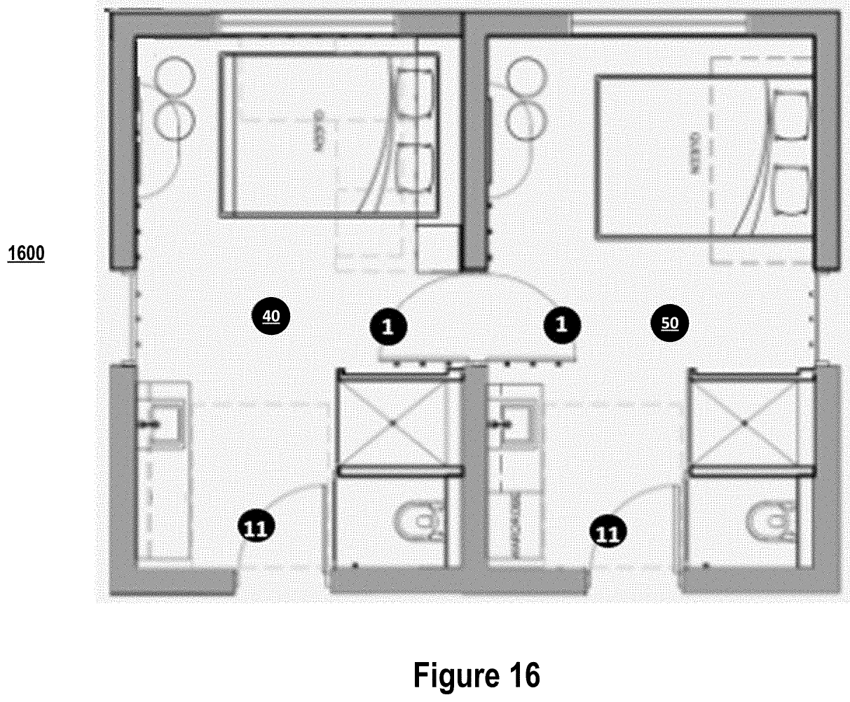

As described herein, a linked room combination may comprise a plurality of linked rooms, each associated with a respective room data record comprising various room attribute data. For example, as shown in FIGS. 16-21, a linked room combination may comprise two, three, or four linked rooms. In various embodiments, the hospitality system 105 may accommodate a linked room combination of four or more linked rooms. The respective rooms of the plurality of linked rooms of a linked room combination may have either the same or different room types, each room type being defined by a room type identifier. As non-limiting examples, a room type identifier may indicate that a room is one of a standard room, a bunk room, a flex room, and a corner room. Further, the respective rooms of the plurality of linked rooms of a linked room combination may have either the same or different room capacities, each room capacity being defined by a room capacity identifier. As used herein, a room capacity identifier may be one or more items of data by which a maximum number of guests that may sleep in a particular room may be uniquely identified. Both a room type identifier and a room capacity identifier may be associated with a room identifier and may comprise ASCII text, a pointer, a memory address, and/or the like. The room attribute data associated with a room identifier associated with particular room may comprise both the room type identifier and the room capacity identifier.

For example, FIG. 16 depicts a floorplan of a possible linked room combination. In this exemplary configuration, the linked room combination 1600 is defined by two rooms, each corresponding to a respective room data record comprising a room identifier, a hotel identifier associated with the hotel in which the two rooms are located, a linked room indicator, a room availability indicator, a room type identifier and a room capacity identifier. As shown, linked room combination 1600 comprises a Flex Room 40 and a Bunk Room 50, with the Flex Room shown as having the bed in the lowered position. Accordingly, the room data records corresponding the two rooms may comprise a room type identifier indicating that the room is a Flex Room and Bunk Room, respectively. Further, the room data record corresponding to the Flex Room 40 may comprise a room capacity identifier of “Two,” indicating that the room may have the capacity to sleep two guests, while the room data record corresponding to the Bunk Room 50 may comprise a room capacity identifier of “Three,” indicating that the room may have the capacity to sleep three guests. The two rooms in exemplary linked room combination 1600 are linked via the linking doors 1 so as to create a single linked corridor 14 that runs continuously through the entirety of the customer's plurality of rooms. In one embodiment, the linked corridor 14 can be created by respectively unlocking each of the linking doors 1 from inside each of the rooms to be linked. The linking doors 1 can require unlocking from both sides before they are openable, or may comprise two adjacent but separate doors that are each unlocked from a respective room. Although the linked doors 1 are shown to create a linear linked corridor 14, other embodiments contemplate linked doors 1 arranged in an offset configuration, wherein the plurality of linked doors 1 are not aligned in a linear fashion, but rather are positioned at different locations in the respective rooms so as to prevent a continuous line of sight throughout the linked corridor 14. For example, such an exemplary combination may most effectively and efficiently suit the specific travel needs of a family of five.

FIG. 17 depicts a floorplan of another possible linked room combination wherein the plurality of linked rooms comprises two rooms, each corresponding to a respective room data record comprising a linked room indicator. In this exemplary combination, the linked room combination 1700 comprises a Standard Room 20 and a Flex Room 40, with the Flex Room arranged so as to have the bed in the raised position to facilitate social interaction. Accordingly, the room data records corresponding to the two rooms may comprise a room type identifier indicating that the rooms are a Standard Room and Flex Room, respectively. Further, the respective room data records corresponding to the Standard Room 20 and the Flex Room 40 may each comprise a room capacity identifier of “Two,” indicating that the room may have the capacity to sleep two guests. The two rooms in exemplary linked room combination 1700 are linked via the linking doors 1 so as to create a single linked corridor 14 that runs continuously through the entirety of the customer's plurality of rooms. For example, such an exemplary configuration may most effectively and efficiently suit the specific travel needs of a solo traveler or a couple looking to entertain guests.

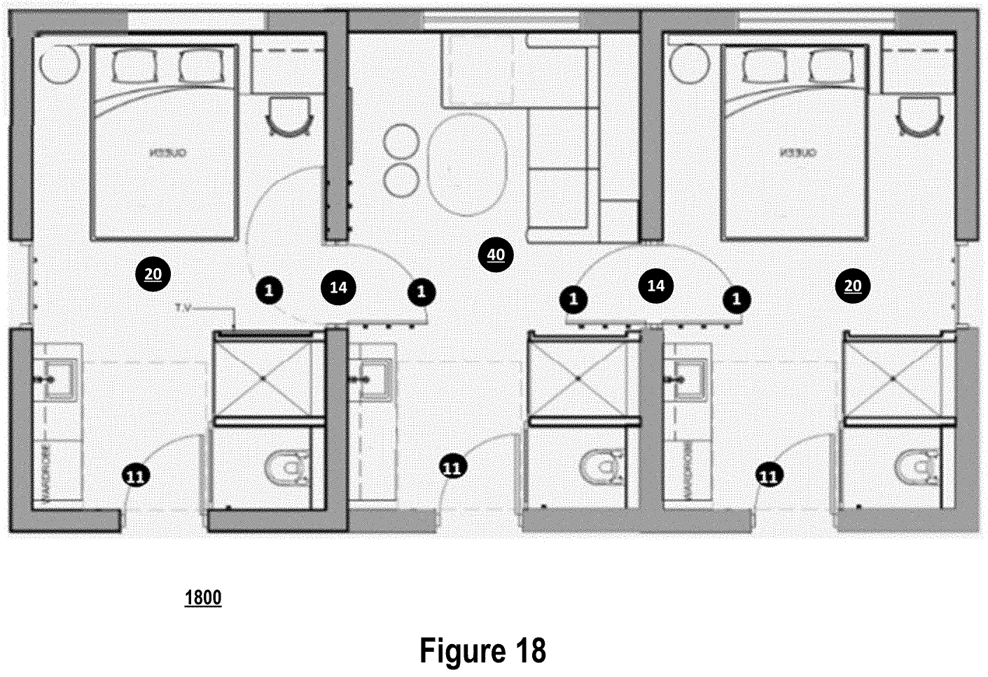

FIG. 18 depicts a floorplan of an exemplary linked room combination wherein the plurality of linked rooms comprises three rooms, each corresponding to a respective room data record comprising a linked room indicator. In this exemplary combination, the linked room combination 1800 linked two Standard Rooms 20 and a Flex Room 40, with the Flex Room arranged so as to have the bed in the raised position to create a dually accessible living room that facilitates collaboration. Accordingly, the room data records corresponding to the three rooms may comprise a room type identifiers indicating that the rooms are a Standard Room, a Flex Room, and a Standard Room, respectively. Further, the respective room data records corresponding to the two Standard Room 20 and the Flex Room 40 may each comprise a room capacity identifier of “Two,” indicating that the room may have the capacity to sleep two guests. The three rooms in linked room combination 1800 are linked via the linking doors 1 so as to create a single linked corridor 14 that runs continuously through the entirety of the customer's plurality of rooms. For example, such an exemplary configuration may most effectively and efficiently suit the specific travel needs of a work group, travelling together for business, in need of a “war room” for group collaboration.

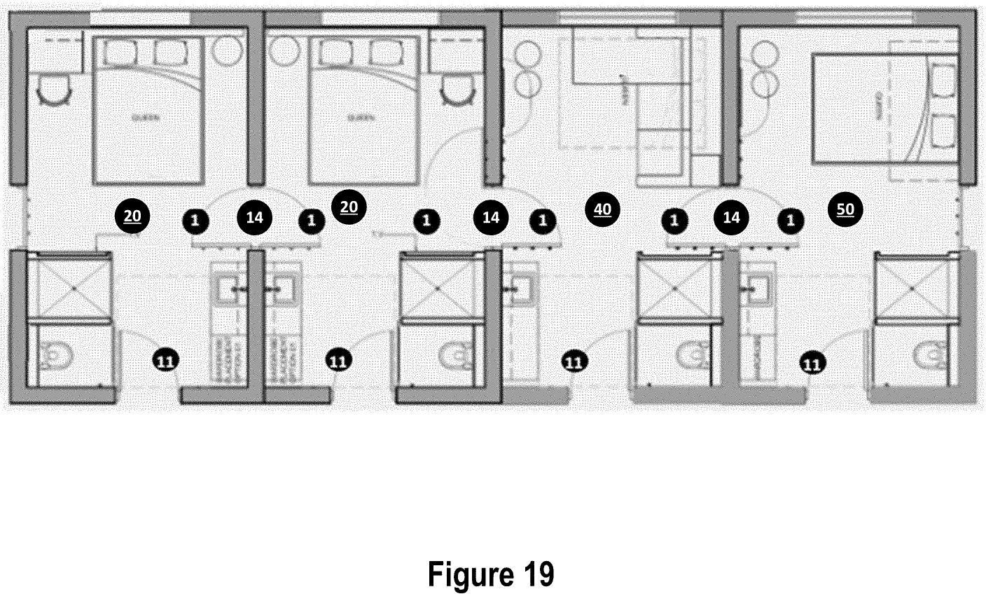

FIG. 19 depicts a floorplan of an exemplary linked room combination wherein the plurality of linked rooms comprises four rooms, each corresponding to a respective room data record comprising a linked room indicator. In this exemplary combination, the linked room combination 1900 comprises two Standard Rooms 20, a Flex Room 40, and a Bunk Room 50, with the Flex Room arranged so as to have the bed in the raised position to facilitate social interaction. Accordingly, the room data records corresponding to the four rooms may comprise a room type identifiers indicating that the rooms are a Standard Room, a Standard Room, a Flex Room, and a Bunk Room, respectively. Further, the respective room data records corresponding to the two Standard Room 20 and the Flex Room 40 may each comprise a room capacity identifier of “Two,” indicating that the room may have the capacity to sleep two guests, while the room data record corresponding to the Bunk Room 50 may comprise a room capacity identifier of “Three,” indicating that the room may have the capacity to sleep three guests. The four rooms in exemplary linked room combination 1900 are linked via the linking doors 1 so as to create a single linked corridor 14 that runs continuously through the entirety of the customer's plurality of rooms. For example, such an exemplary configuration may most effectively and efficiently suit the specific travel needs of a friend group of nine traveling together.

Referring back to FIG. 14A, as shown at Block 1410, the hotel server 110 may compare at least a portion of the room attribute data associated, respectively, with each room identifier associated with the plurality of linked rooms of a linked room combination to one or more of the plurality of requested reservation parameters received as inputs to the hospitality system 105. In various embodiments, such a comparison may be made by the hotel server 110 in order to determine which of the available at least one linked room combinations satisfy the plurality of requested reservation parameters, and, thus, should be presented as an appropriate option for reservation. For example, in various embodiments, the plurality of requested reservation parameters may specify a particular hotel at which a user is looking for a linked room combination. As a further example, the plurality of requested reservation parameters may specify a requested number of rooms a guest is looking to reserve or a number of guests in the user's party that will be staying at the hotel. The hotel server 110 may compare the room attribute data associated, respectively, with each room identifier associated with each of the plurality of linked rooms of each of the linked room combinations to the plurality of requested reservation parameters received.

As shown at Block 1411, the hotel server 110 may generate an available linked room combination list based at least in part on the comparison described above with respect to Block 1410. As used herein, an available linked room combination list is a listing of linked room combinations identifiers associated with linked room combinations available to a user on a user-specified date that may be presented to the user via a client device. In various embodiments, an available linked room combination list may include at least a subset (or all) of the linked room combinations available to a user based on the plurality of requested reservation parameters received by the hotel server 110. For example, in various embodiments, the plurality of requested reservation parameters may specify a particular hotel at which a user is looking for a linked room combination. In response, the hotel server 110 may generate an available linked room combination list wherein each of the linked room combination identifiers included in the list is associated with a hotel identifier associated with the selected hotel. As a further example, in various embodiments, the plurality of requested reservation parameters may specify a requested room count. In response, the hotel server 110 may generate an available linked room combination list wherein each of the linked room combination identifiers included in the list is associated with a linked room combination comprising a number of rooms that is equal to the requested room count. As a further non-limiting example, in various embodiments, the plurality of requested reservation parameters may specify a requested guest count. In response, the hotel server 110 may generate an available linked room combination list wherein each of the linked room combination identifiers included in the list is associated with a plurality of room capacity identifiers, the sum of which is greater than or equal to the requested guest count. As described herein, the hotel server 110 may effectively filter the at least one linked room combinations to surface in the available linked room combination list only those that satisfy the requested reservation parameters received by the hotel server 110.

Additionally, the available linked room combination list may be generated by the hotel server 110 in accordance with the prioritization of those rooms associated with a singular adjacent linked room indicator over those rooms associated with a dual adjacent linked room indicator, as discussed herein. For example, in various embodiments wherein the hotel server 110 has filtered the at least one linked room combinations to identify a subset of the linked room combinations that satisfy all of the requested reservation parameters received by the hotel server 110, the hotel server 110 may include in the available linked room combination list only those linked room combination identifiers associated with at least one room data record comprising a singular adjacent linked room indicator. Alternatively, in various embodiments, the hotel server 110 may filter the at least one linked room combinations associated with at least one room data record comprising a singular adjacent linked room indicator in order to identify a subset of the linked room combinations associated with at least one room data record comprising a singular adjacent linked room indicator that satisfy all of the requested reservation parameters received by the hotel server 110. Further, in various embodiments wherein the hotel server 110 has filtered the at least one linked room combinations to identify a subset of the linked room combinations that satisfy all of the requested reservation parameters received by the hotel server 110, and wherein the hotel server 110 has determined that none of the linked room combinations that satisfy all of the requested reservation parameters are associated with a linked room combination identifier associated with a room data record comprising a singular adjacent linked room indicator, the hotel server 110 may include in the available linked room combination list those linked room combination identifiers associated exclusively with room data records comprising a dual adjacent linked room indicator. As described herein, the hotel server 110 may selectively surface to a user for reservation those linked room combinations wherein one of the room identifiers is associated with a singular adjacent linked room identifier before surfacing a linked room combination made exclusively of rooms respectively associated with a dual adjacent linked room indicator. The hotel server 110 may render the available linked room combination list for display at the client device 102 from which the room availability query was received.

In various embodiments, such as, for example, when a plurality of requested reservation parameters comprises a requested guest count, the hotel server 110 may surface a suggested linked room combination identifier to be included in an available linked room combination list. For example, the suggested linked room combination identifier may be associated with a room availability indicator and may be determined to comprise various room attribute data similar to that of a linked room combination identifier which would satisfy each of the requested reservation parameters (e.g., requested guest count) of the room availability query. As a non-limiting example, the hotel server 110 may execute one or more executable instructions corresponding to a linked room combination suggestion wizard, which may generate a suggested linked room combination based at least in part on user input received by the hotel server 110.

As shown at Block 1412, the hotel server 110 may transmit the available linked room combination list to the client device 102, which may display the available linked room combination list at a display device associated therewith. In various embodiments, each of the linked room combination identifiers of the available linked room combination list may be displayed along with various data associated therewith. For example, various room attribute data and a collective reservation price and/or nightly price for the linked room combination (or for each of the rooms thereof) may be displayed along with the available linked room combination list. In various embodiments, the client device 102 may display the available linked room combination list so as to facilitate the receipt of a reservation request, as shown in Block 1413, which may be embodied as a selection of one of the linked room combinations of the available linked room combination list. A reservation request may comprise data associated with a linked room combination identifier (e.g., and each of the room identifiers associated therewith) that indicates that the user associated with the client device 102 wishes to reserve the linked room combination associated with the selected linked room combination identifier for a user-defined date or set of dates. In various embodiments, a reservation request may be defined, as least in part, based on one or more of the plurality of requested reservation parameters defined by the room availability query received by the hotel server 110 from the client device. As shown at Block 1414, the hotel server 110 may receive the reservation request from the client device 102.

In various embodiments, a reservation request may further comprise various additional reservation data such as, for example, data associated with one or more of the guests associated with the user's party who are staying in one of the plurality of linked rooms during the duration of the reservation associated with the reservation request. For example, a reservation request may comprise various data such as a guest name identifier associated with one or more of the guests, a guest profile identifier associated with a loyalty account associated with the one or more of the guests and the hospitality enterprise, various payment data (e.g., credit card information) associated with one or more of the guests, payment information, as discussed herein. In such an exemplary circumstance, the hotel server 110 may associate one or more guests associated with at least a portion of the reservation data with a particular room of the plurality of linked rooms of the linked room combination, based at least in part on the reservation request. The hotel server 110 may generate loyalty points as a result of a confirmed reservation. In various embodiments, wherein a reservation request associated with a user is further associated with a linked room combination identifier and one or more guest profile identifiers associated with the hospitality enterprise and a guest associated with the user's party, the hotel server 110 may selectively allocate the loyalty points generated as a result of the confirmed reservation corresponding to the reservation request to one or more of the guests of the user's party and/or the user. For example, the hotel server 110 may allocate the entirety of the loyalty points generated as a result of the confirmed reservation corresponding to the reservation request to the user associated with the reservation request. As a further non-limiting example, the hotel server 110 may evenly distribute the loyalty points generated as a result of the confirmed reservation corresponding to the reservation request so as to allocate an equal percentage of the points to each of the one or more guest profile identifiers associated with the reservation request. As a further non-limiting example, the hotel server 110 may allocate the loyalty points generated as a result of the confirmed reservation corresponding to the reservation request based on one or more priority factors, such as, for example, guest loyalty status such that the points are distributed proportionally to each of the one or more guest profile identifiers associated with the reservation request according to a guest's prior stay history at various hotels of the hospitality enterprise.

Upon receiving a reservation request associated with a linked room combination identifier of the available linked room combination list, the hotel server 110 may selectively disassociate each room identifier associated with the linked room combination identifier associated with the reservation request from the room availability indicator associated therewith, as shown at Block 1415 of FIG. 14B. The room availability indicator may be selectively disassociated with each of the room identifiers associated with the selected linked room combination identifier so as to indicate that each of the rooms associated with the room identifiers is not available to be reserved on the dates defined by the reservation request, such that the hotel server 110 will not generate a linked room combination identifier associated with any of the room identifiers in response to a subsequently received room availability query received from a different client device. In various embodiments, the hotel server 110 may generate a confirmed reservation identifier associated with, for example, a user profile associated with the user associated with the client device 102, the hotel identifier, the linked room combination identifier and each of the room identifiers associated therewith, and/or the like. In various embodiments, upon disassociating the plurality of room identifiers associated with the selected linked room combination identifiers with the respective room availability indicators associated therewith, the hotel server 110 may provide a booking confirmation response to the client device 102, as indicated at Blocks 1416 and 1417. In certain embodiments, a booking confirmation message may be displayed at the client device 102.

As shown at Blocks 1418 and 1419, the hotel server 110 may receive from the client device 102 a cancellation request associated with a confirmed reservation identifier associated with a reservation of a linked room combination. In various embodiments, a cancellation request may comprise data associated with a confirmed reservation identifier and/or a linked room combination (e.g., and each of the room identifiers associated therewith) that indicates that the user associated with the client device 102 wishes to modify the reservation of the linked room combination associated with a linked room combination identifier associated with a reservation request transmitted to the hotel server 110 by a client device 102 associated with the user. For example, a cancellation request may indicate a user's desire to reduce the number of rooms of the linked room combination by one room. In such a circumstance, the hotel server 110 may be configured to determine which of the plurality of linked rooms of the linked room combination should be removed from the reservation.

In various embodiments, the hotel server 110 may selectively remove one of the plurality of linked rooms from the reservation associated with the cancellation request so as to maintain a plurality of linked rooms, if possible. For example, the hotel server 110 may selectively remove from the reservation associated with the cancellation request one of the two outermost rooms of the plurality of linked rooms of the linked room combination, as shown at Block 1419. In various embodiments, the hotel server 110 may determine which of the plurality of linked rooms are the two outermost rooms by determining which of two room data records associated with the linked room combination identifier comprises an adjacent room identifier corresponding to a room identifier that is not associated with the linked room combination identifier. Further, in various embodiments, the hotel server 110 may determine which of the two outermost rooms of the plurality of linked rooms of the linked room combination to remove from the reservation based on which of the two room data records respectively associated with the two outermost rooms comprises a dual adjacent linked room indicator.

For example, as shown at Block 1421, the hotel server 110 may parse each of the room data records associated with the linked room combination identifier to detect each room data record comprising a dual adjacent linked room indicator in order to determine which of the plurality of linked rooms of the linked room combination should be disassociated with the linked room combination such that it is no longer reserved as a part of the reservation associated with the confirmed reservation identifier. In various embodiments, the hotel server 110 may prioritize removing a room associated with a room data record comprising a dual adjacent linked room combination indicator over a room associated with a room data record comprising a singular indicator linked room combination identifier. For example, where only one of the room data records associated respectively with the two outermost rooms of the plurality of linked rooms of the linked room combination identifier comprises a dual adjacent linked room indicator, the hotel server 110 may determine that the room identifier associated with the room data record comprising the dual adjacent linked room indicator should be selectively disassociated with the linked room combination identifier. Alternatively, upon determining that either both or neither of the one of the two room data records associated respectively with the two outermost rooms of the plurality of linked rooms of the linked room combination identifier comprises a dual adjacent linked room indicator, the hotel server 110 may determine which of the two outermost rooms to drop from the reservation associated with the cancellation request based in part on a determination that only one of the two room data records respectively associated with the two outermost rooms comprises an adjacent room identifier corresponding to a room identifier that is associated with a room data record comprising a room availability indicator. Further, in various embodiments, upon making a determination as to which of the plurality of linked rooms to remove from the reservation, the hotel server 110 may verify that the updated linked room combination (i.e. the remaining plurality of rooms) will sufficiently accommodate the requested reservation parameters defined by the reservation request. For example, where the cancellation request comprises updated requested reservation parameters (e.g., an updated number of guests), the hotel server 110 may verify that the sum of the room capacity identifiers associated with each of the remaining plurality of linked rooms is greater than or equal to the user-defined number of guests.

As shown at Block 1422, the hotel server 110 may disassociate one or more room identifiers associated with one or more rooms selected to be removed from the reservation associated with the cancellation request from the linked room combination identifier. Further, as shown at Block 1423, the hotel server may associate the one or more identifiers associated with one or more rooms selected to be removed from the reservation associated with the cancellation request with a room availability indicator.

As shown at Block 1424, the hotel server 110 may selectively allocate at least a portion of room credential data associated with at least one of the room identifiers associated with the linked room combination identifier to at least one of the guests associated with a guest profile associated with the reservation request. As used herein, room credential data may comprise one or more collections of data associated with a room identifier that may be utilized to verify that a particular guest is authorized to access a room associated with the room identifier and/or utilize technological functionalities therein. For example, room credential data may comprise data in either a physical keycard or data defining a digital key that may be used to gain access into a room associated with a room identifier associated therewith. As a further example, room credential data may comprise data transmitted to a device that may be used to enable a technological feature of a room associated with the room identifier, such as, for example, an internet of things and/or content control functionality that may be enabled by a device located in the room associated with the room identifier upon the receipt of the room credential data by the device. Each reservation request received by the hotel server 110 may be associated with guest profile associated with the hospitality enterprise, wherein the guest profile is associated with the user associated with the client device 102. In various embodiments, a reservation request may be associated with a plurality of guest profiles, each being associated with a respective guest in the same party as the user associated with the client device 102. Where the reservation request is associated with a linked room combination and a plurality of guest profiles, the hotel server 110 may selectively distribute various room credential data associated with each respective room identifier associated with the linked room combination identifier to one or more of the guests associated with the plurality of guest profiles. For example, where each guest profile is associated with a room identifier associated with one of the plurality of linked rooms of the linked room combination, at least one of the guest profiles associated with at least one of the room identifiers may be transmitted to a device associated with the guest profile.

As shown at Blocks 1425 and 1426, a client device 102 may generate a room availability query comprising a linked room request based at least in part on the user input received a user interface associated with the hotel enterprise associated with the hotel server 110, which may be transmitted to the group-based communication server 110. As described herein, a single room request may comprise data received by the hotel server 110 as a result of a user associated with the client device 102 indicating a desire for a single room. In various embodiments, a single room request may be based on a selection by a user at a client device 102 or may be generated by the hotel server 110 based on at least one other requested reservation parameters, such as the requested guest count, the requested room count, and the hotel identifier.

Upon receiving a room availability query comprising a single room request, a hotel server 110 may parse a hotel inventory repository 120 to detect at least one room data record comprising a single room indicator, as shown at Block 1427. In various embodiments, a single room indicator associated with a room identifier may indicate that the room associated with the single room identifier is a single room such that it may not be selectively linked to one or more adjacent linkable rooms. For example, the hotel server 110 may detect each room data record comprising a single room indicator so as to identify each room of a hotel enterprise associated with the hospitality system 105 that is a single room. As described herein, a hotel may comprise both single rooms and linked rooms. In various embodiments, upon receiving a room availability query comprising single room request, a hotel server 110 may be configured to prioritize those rooms associated with a single room indicator over those rooms associated with a linked room indicator, such that room identifiers associated with a single room indicator may be selectively surfaced to a user for reservation before those room identifiers associated with a linked room indicator. For example, where a majority of the room identifiers associated with the rooms of a hotel are associated with a single room identifier, in response to receiving a room availability query comprising single room request, the hotel server 110 may be configured to book those rooms associated with a single room indicator before booking those rooms associated with a linked room indicator.

As shown at Block 1428 of FIG. 14C, the hotel server 110 may parse each of the room data records comprising a single room indicator, detected as described above with respect to Block 1427, to detect at least one room data record of the room data records comprising a single room indicator further comprising a room availability indicator. For example, the hotel server 110 may detect each room data record comprising a single room indicator that further comprises a room availability indicator so as to identify each single room of a hotel enterprise associated with the hospitality system 105 that is available to be reserved in a linked room combination on a given day.

In various embodiments, the hotel server 110 may fail to detect a room data record comprising both a single room indicator and an available room indicator. In such a circumstance, as shown at Block 1429, the hotel server 110 may be configured to parse the hotel inventory repository 120 to detect at least one room data record(s) comprising a linked room indicator. Further, the hotel server 110 may parse each of the room data records comprising a linked room indicator to detect at least one room data record of the room data records comprising a linked room indicator further comprising a room availability indicator, as described herein. For example, the hotel server 110 may detect each room data record comprising a linked room indicator that further comprises a room availability indicator so as to identify each linkable room of a hotel enterprise associated with the hospitality system 105 that is available to be reserved as a single room on a given day.

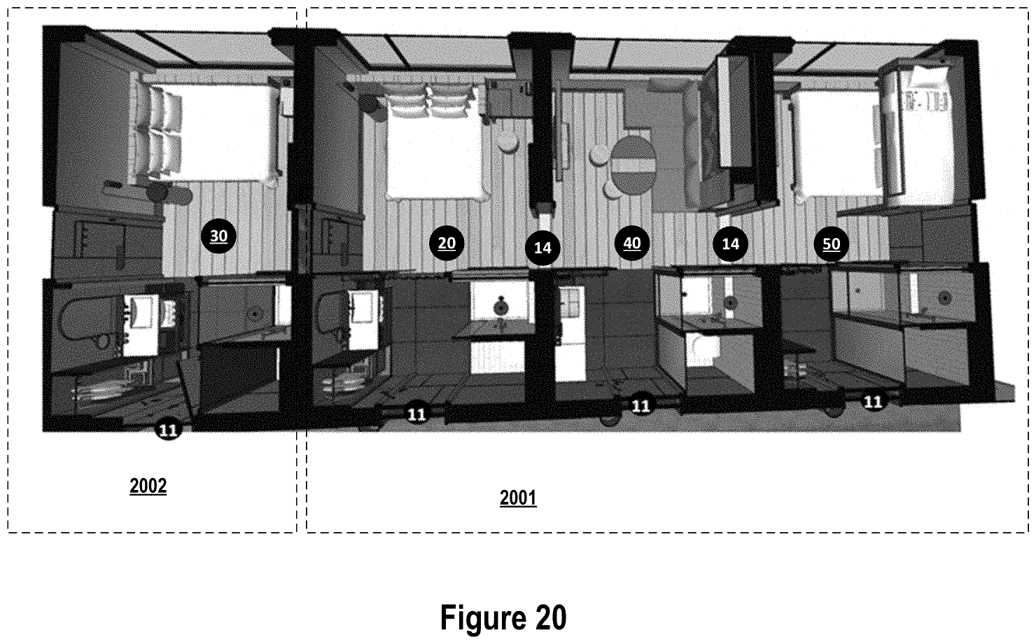

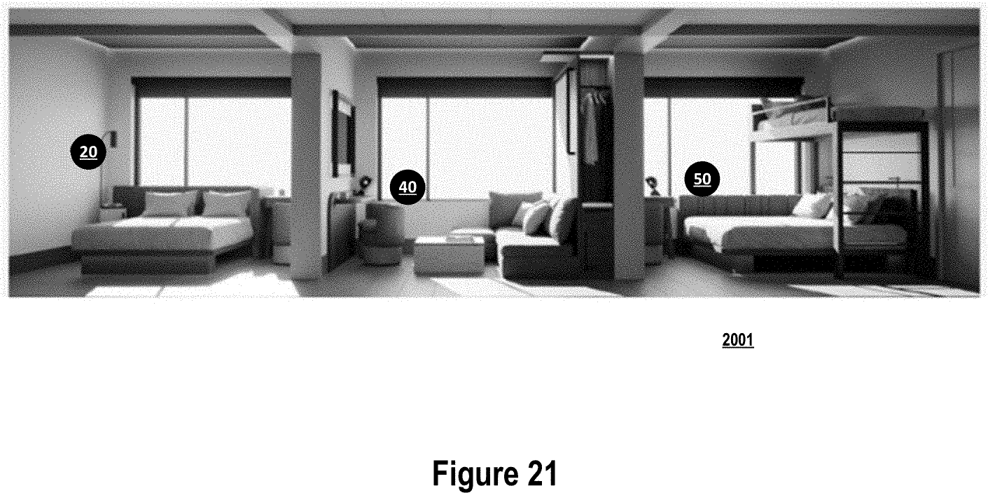

As an illustrative and non-limiting example, FIGS. 20 and 21 display an exemplary linked room combination 2001 comprising three linked rooms. FIG. 20 is a perspective top view of the interior of a four-room block of adjacent linkable rooms, three of which define the exemplary linked room combination 2001, while FIG. 21 provides an alternative cutaway front view of the selectively linked three-room linked room combination 2001 depicted in FIG. 20. As shown, linked room combination 2001 comprises a Standard Room 20, a Flex Room 40, and a Bunk Room 50, with the Flex Room arranged so as to have the bed in the raised position to facilitate social interaction. The three linkable rooms in linked room combination 2001 have been selectively linked via the linking doors 1 so as to create a single linked corridor 14 that runs continuously through the entirety of the customer's plurality of rooms. Also illustrated in FIG. 20 is a Corner Room 30 embodied as a linked room 2002 that is not included in linked room combination 2001 (i.e. it has not been selectively linked to the other three rooms defining the plurality of linked rooms of the linked room combination 2001). For example, the room data record associated with linked room 2002 may comprise a linked room indicator and a room availability indicator but does not comprise the linked room combination identifier associated with linked room combination 2001. Further, the room data record associated with linked room 2002 may comprise a singular adjacent linked room indicator as the Standard Room 20 of the linked room combination 2001 is a linked room and the room located adjacent linked room 2002 opposite of the Standard Room 20 is a single room (i.e. corresponds to a room data record comprising a single room indicator. For example, upon receiving a room availability query comprising a single room request and determining that none of the room data records corresponding to the various rooms of the hotel comprise both a single room indicator and a room availability indicator, the hotel server 110 may parse the hotel inventory repository 120 to detect at least one room data record(s) comprising a linked room indicator and a room availability indicator, as described above with respect to Block 1429. Upon detecting that the room data record associated with linked room 2002 comprises both a linked room indicator and a room availability indicator, the hotel server 110 may determine that linked room 2002 may potentially be surfaced to a user as an option for reservation, as discussed herein, despite being a linked room.

In order to minimize the effect that booking a linkable room (i.e. a room corresponding to a room data record comprising both a linked room indicator and a room availability indicator) as a single room may have on the efficiency of the hospitality system 105, as described herein, the hotel server 110 may be configured to prioritize those rooms associated with a singular adjacent linked room indicator over those rooms associated with a dual adjacent linked room indicator, such that rooms associated with a room identifier associated with a singular adjacent linked room indicator may be selectively surfaced to a user for reservation before those associated with a room identifier associated with a dual adjacent linked room indicator. For example, as shown at Block 1430, the hotel server 110 may parse each of the room data records comprising both a linked room indicator and a room availability indicator, detected as described above with respect to Block 1429, to detect at least one room data record comprising a singular adjacent linked room indicator. In various embodiments, as shown at Block 1431, the hotel server 110 may parse each of the room data records comprising both a linked room indicator and a room availability indicator to detect at least one room data record of the room data records comprising both a linked room indicator and a room availability indicator that further comprises a dual adjacent linked room indicator. For example, the hotel server 110 may execute the operations described with respect to Block 1431 upon determining that there are no room data records comprising both a room availability indicator and a singular adjacent linked room indicator.

Referring back to FIG. 14C, as shown at Block 1432, the hotel server 110 may compare at least a portion of the room attribute data associated, respectively, with each of the at least one room identifiers associated with a room availability indicator to one or more of the plurality of requested reservation parameters received as inputs to the hospitality system 105. In various embodiments, such a comparison may be made by the hotel server 110 in order to determine at least one available room that satisfies the plurality of requested reservation parameters, and, thus, should be presented to a user as an appropriate option for reservation. For example, in various embodiments, the plurality of requested reservation parameters may specify a particular hotel at which a user is looking for a linked room combination. As a further example, the plurality of requested reservation parameters may specify a requested room type a guest is looking to reserve or a number of guests in the user's party that will be staying at the hotel. The hotel server 110 may compare the room attribute data associated, respectively, with each of the at least one room identifiers associated with a room availability indicator to the plurality of requested reservation parameters received.

As shown at Block 1433, the hotel server 110 may generate an available room list based at least in part on the comparison described above with respect to Block 1432. As used herein, an available room list is a listing of room identifiers associated available to a user on a user-specified date that may be presented to the user via a client device. In various embodiments, an available room list may include room identifiers of at least a subset (or all) of the rooms available to a user based on the plurality of requested reservation parameters received by the hotel server 110. For example, in various embodiments, the plurality of requested reservation parameters may specify a particular hotel at which a user is looking for a room. In response, the hotel server 110 may generate an available room list wherein each of the room identifiers included in the list is associated with a hotel identifier associated with the selected hotel. As a further example, in various embodiments, the plurality of requested reservation parameters may specify a requested room type. In response, the hotel server 110 may generate an available room list wherein each of the room identifiers included in the list is associated with a room type identifier corresponding to the requested room type. As a further non-limiting example, in various embodiments, the plurality of requested reservation parameters may specify a requested guest count. In response, the hotel server 110 may generate an available room list wherein each of the room identifiers included in the list is associated with a room capacity identifier that is greater than or equal to the requested guest count. As described herein, the hotel server 110 may effectively filter the available rooms to surface in the available room list only those that satisfy the requested reservation parameters received by the hotel server 110. As described above, in various embodiments, an available room list may comprise available single rooms and/or available linked rooms.

As shown at Block 1434, the hotel server 110 may transmit the available room list to the client device 102, which may display the available room combination at a display device associated therewith. In various embodiments, each of the room identifiers of the available room list may be displayed along with various data associated therewith, such as, for example, various room attribute data and/or pricing data associated therewith. In various embodiments, the client device 102 may display the available room list so as to facilitate the receipt of a reservation request, as shown in Block 1435, which may be embodied as a selection of one of the rooms of the available room list. A reservation request may comprise data associated with the room identifier (e.g., and each of the room identifiers associated therewith) that indicates that the user associated with the client device 102 wishes to reserve the room associated with the selected room identifier for a user-defined date or set of dates. In various embodiments, a reservation request may be defined, as least in part, based on one or more of the plurality of requested reservation parameters defined by the room availability query received by the hotel server 110 from the client device. As shown at Block 1436, the hotel server 110 may receive the reservation request from the client device 102.

Upon receiving a reservation request associated with a room identifier of the available linked room combination list, the hotel server 110 may selectively disassociate the room identifier associated with the associated with the reservation request from the room availability indicator associated therewith, as shown at Block 1437. The room availability indicator may be selectively disassociated with the room identifier associated with the selected room identifier so as to indicate that the room associated with the room identifier is not available to be reserved on the dates defined by the reservation request. As such, the hotel server 110 may not surface the room identifier as an available option for reservation in response to a subsequently received room availability query received from a different client device. In various embodiments, the hotel server 110 may generate a confirmed reservation identifier associated with, for example, a user profile associated with the user associated with the client device 102, the hotel identifier, the room identifier associated therewith, and/or the like. In various embodiments, upon disassociating the room identifier from the room availability indicator previously associated therewith, the hotel server 110 may provide a booking confirmation response to the client device 102, as indicated at Blocks 1438 and 1439, and as described herein.

As shown at Block 1440, the hotel server 110 may associate each room identifier associated with a linked room combination identifier with a room availability indicator upon the ending of a reservation thereof (i.e. checkout). In various embodiments, the hotel server 110 may determine that a guest has checked out based at least in part on the reservation data associated with the room identifier. In various embodiments, each room identifier associated with a room of the plurality of linked rooms of the linked room combination may be associated with a respective room availability indicator upon a determination by the hotel server 110 that the guests staying in each of the rooms of the plurality of linked rooms have checked out. Alternatively, a room identifier associated with a room of the plurality of linked rooms of the linked room combination may be associated with a respective room availability indicator upon a determination by the hotel server 110 that at least the guests staying in the particular room of the plurality of linked rooms associated with the room identifier have checked out.

In various embodiments, a reservation request, as described herein, may comprise a split payment request comprising data received by the hotel server 110 as a result of a user associated with the client device 102 indicating a desire for a reservation to be paid for a two or more people. As shown in FIG. 15, the hospitality system 105 may be configured to accommodate a split payment request. FIG. 15 is a flowchart illustrating example steps for accommodating a reservation request comprising a split payment request in accordance with various embodiments. The exemplary method 1500 begins at Block 1501, with receiving a reservation request associated with a client device comprising a split payment request. As described herein, the reservation request may comprise payment data associated with the user associated with the client device 102 that is associated with the reservation request. For example, payment data may comprise various data corresponding to one or more methods of payment as input by a user. In various embodiments, payment data may comprise credit card information, bank routing information, gift card information, and/or the like. In various embodiments, a split payment request may be associated with a user associated with the client device 102, one or more user profiles, a confirmed reservation identifier, one or more additional guests, each of which is a member of the user's reservation party, and/or the like.

Upon receiving a reservation request comprising a split payment request, the method 1500 continues, at Block 1502, with determining whether there is any unknown information that is required in order to accommodate the split payment request. For example, a guest identifier, a third party financial transfer resource identifier and/or payment data associated with at least one of the additional guests associated with the split payment request may not have been defined by the reservation request and/or the split payment request. As described herein, in order to execute a split payment so as to accommodate a split payment request associated with a reservation, a hospitality system must have received payment data associated with each of the guests associated with the split payment request. In various embodiments, payment data associated with a guest may be received by the hospitality system as user input received from a client device. Alternatively and/or additionally, payment data associated with a guest may be associated with the guest profile of the guest such that it may be stored in a repository associated with the hotel enterprise and retrieved by a hotel server with the guest's permission.

In various exemplary circumstances wherein all of the required information needed to accommodate the split payment request was detected (e.g., there is no missing guest payment data), the method 1500 continues, at Block 1503, with booking the reservation using at least the payment data associated with each of the at least one additional guests associated with the split payment request. As described herein, booking the reservation may comprise generating a confirmed reservation identifier. Further, as described herein, upon booking the reservation using the various payment data associated with each of the additional guests associated with the split payment request, the method 1500 continues, at Block 1504, with transmitting a booking confirmation to at least one client device associated with a guest associated with the split payment request. For example, the booking confirmation may be transmitted to the client device associated with the user associated with the reservation request. In various embodiments, a booking confirmation may be transmitted to each of the client devices associated with a guest associated with the split payment request.

Referring back to Block 1502, upon receiving a reservation request comprising a split payment request, in various exemplary circumstances wherein unknown information required in order to accommodate the split payment request was detected, the method 1500 continues, at Block 1505, with determining whether or not split payment notice deadline has already passed. As described herein, a split payment notice deadline may be defined by a minimum number of days in advance of the check-in date of a reservation that a split payment request associated with the reservation request may be received in order for a hospitality system to attempt to accommodate the split payment request within first booking the reservation with the payment data of the user associated with the reservation. In various embodiments, the check-in date may be defined by the reservation data associated with the reservation request with which the split payment request is associated. For example, a split payment notice deadline may be a day 30 days before the check-in date of a reservation, meaning that in response to receiving a split payment request less than 30 days in advance of a check-in date of a reservation, the hospitality system will create the reservation using the payment data of the user associated with the reservation request.

In various exemplary circumstances wherein a split payment request is received before a split payment notice deadline, the method 1500 continues as Block 1506, with transmitting at least one split payment notification to a respective client device associated with each of the additional guests associated with the split payment request. In various embodiments, the split payment notification may comprise reservation data (e.g., room number(s), room attribute data, reservation dates, reservation price data) and/or a message indicating that payment data associated with the additional guest is required in order to execute a split payment request received by the user associated with the reservation request.

Upon transmitting the at least one split payment notification to respective client devices associated with each of the additional guests associated with the split payment request, the method 1500 continues, at Block 1507, with receiving payment data associated with at least one of the at least one additional guests associated with the split payment request. In various embodiments, the payment data associated with an additional guest associated with the split payment request may be received by a hospitality system from the client device associated with the guest associated with the payment data.

Prior to the check-in date of the reservation associated with the reservation request, the method 1500 continues, at Block 1508, with determining whether or not payment data has been received from each of the additional guests associated with the split payment request. As shown, in various exemplary circumstances wherein the payment data of each of the at least one additional guests associated with the split payment request has been received, the method continues, at Block 1503, with booking the reservation using at least the various payment data associated with each of the additional guests associated with the split payment request, as described herein.

Referring back to Block 1508, prior to the check-in date of the reservation associated with the reservation request and in various exemplary circumstances wherein it is determined that payment data associated with at least one of the additional guests associated with the split payment request has not been received, a reservation request comprising a split payment request, unknown information required in order to accommodate the split payment request was detected, the method 1500 continues, at Block 1509, with canceling at least a portion of the reservation (e.g., removing a room, removing one of the reservation days) associated with the reservation request based on input received from the user associated with the reservation request. For example, where that payment data associated with at least one of the additional guests associated with the split payment request has not been received, the hospitality system may transmit an incomplete payment notification to the user associated with the reservation request requesting input regarding the user's preferred course of action with respect to the reservation. In various embodiments, the user associated with the reservation request may elect to pay the remaining balance left unpaid by the at least one additional guest associated with the split payment request from whom payment data was not received. Alternatively, the user associated with the reservation request may elect to cancel either the entire reservation or a portion(s) of the reservation corresponding to the portion of the reservation designated as being assigned to the at least one additional guest associated with the split payment request from whom payment data was not received. For example, the hospitality system may disassociate at least one room identifier associated with one of the plurality of linked rooms associated with the linked room combination identifier associated with the reservation request, as described herein with respect to Block 1422 of FIG. 14B. In such an exemplary circumstance, the hospitality system may book the modified reservation using at least the received payment data associated with each of the additional guests associated with the split payment request.

Upon booking the modified reservation using the various payment data associated with the additional guests associated with the split payment request from whom payment data was received, the method 1500 continues, at Block 1504, with transmitting a booking confirmation to at least one client device associated with a guest associated with the split payment request and from whom payment data was received. For example, the booking confirmation may be transmitted to the client device associated with the user associated with the reservation request. In various embodiments, a booking confirmation may be transmitted to each of the client devices associated with a guest associated with the split payment request.

Referring back to Block 1505, upon receiving a reservation request comprising a split payment request and in various exemplary circumstances wherein the split payment notice deadline is determined to have already passed, the method 1500 continues, at Block 1510, with booking the reservation associated with the reservation request using the payment data associated with the user associated with the reservation request. In various embodiments, the payment data associated with the user associated with the reservation request may be received from the client device associated with the user. For example, the payment data associated with the user associated with the reservation request may be included as part of the reservation request.

Upon booking the reservation using the payment data associated with the user associated with the reservation request, the method 1500 continues, at Block 1511, with transmitting at least one payment request associated respectively with each of the at least one additional guests associated with the split payment request to a to a third-party financial transaction resource, as described herein. In various embodiments, a third-party financial transaction resource may comprise, for example, a server associated with a credit card company or any other entity configured to facilitate a digital financial transaction. Each payment request transmitted to a third-party financial transfer resource may be associated with an identifier associated with the respective additional guest associated with the split payment request such that the third-party financial transfer resource may identify the particular person (e.g., the additional guest associated with the split payment request) with which the third-party financial transfer resource is associated.

Upon transmitting the at least one payment request to at least one third party financial transfer resource, the method 1500 continues, at Block 1512, with receiving payment data associated with at least one of the at least one additional guests associated with the split payment request. In various embodiments, the payment data associated with an additional guest associated with the split payment request may be received by a hospitality system from either the third-party financial transfer resource or a client device associated with the guest associated with the payment data.

Upon receiving payment data associated with at least one of the at least one additional guests associated with the split payment request, the method 1500 continues, at Block 1513, with transmitting at least one payment confirmation notification associated with one of the additional guests associated with the split payment request from whom payment data was received to the client device associated with the user associated with the reservation request. In various embodiments, a payment confirmation notification may indicate that one of the at least one additional guests associated with the split payment request has paid the portion of the reservation price that was assigned to the guest via the split payment request. In various embodiments, the hospitality system may further transmit the at least one payment confirmation notification associated with each of the additional guests associated with the split payment request from whom payment data was received to the respective client devices associated with the additional guest determined to have provided payment data.

While embodiments herein describe a system wherein various room attribute data such as linked room indicator, a single room indicator, an adjacent linked room count identifier, an adjacent linked room identifier, and/or the like comprise static data corresponding to the physical construct of a hotel and the various rooms thereof such that the data will not change over time, example embodiments might also include a system wherein the aforementioned data is dynamic. In such a circumstance, the hospitality system 105 described herein may be configured to execute software and/or the like so as to update the room attribute data dynamically in real time to reflect an update to the data.

### CONCLUSION

Many modifications and other embodiments of the inventions set forth herein will come to mind to one skilled in the art to which the inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for reserving a plurality of hotel rooms in a linked room configuration based at least in part on a linked room request, the system comprising at least one hotel inventory repository and at least one server comprising at least one processor, and at least one non-transitory memory comprising instructions that, with the at least one processor, cause the system to:
receive a room availability query, the room availability query comprising a plurality of requested reservation parameters;
parse a hotel inventory repository to detect at least one room data record comprising a linked room indicator, wherein the hotel inventory repository is configured to store a plurality of room data records, wherein a room data record is associated with a room of a hotel enterprise and comprises a plurality of room attribute data corresponding to the room associated therewith, each plurality of room attribute data comprising at least a room identifier;
parse, upon detecting at least one room data record comprising a linked room indicator, the at least one room data record comprising a linked room indicator to detect at least one room data record comprising a room availability indicator;
generate at least one linked room combination identifier associated with at least one linked room combination based at least in part on the plurality of requested reservation parameters, wherein each of the at least one linked room combinations comprises a plurality of linked rooms, each of the linked rooms of a linked room combination being associated with one of the at least one room data records comprising a room availability indicator, and wherein each of the at least one linked room combination identifiers are respectively associated with each of the room identifiers associated with one of the plurality of linked rooms of the linked room combination associated therewith;
render an available linked room combination list comprising at least one of the at least one the linked room combination identifiers for display, the system being configured to receive a reservation request associated with a linked room combination identifier of the available linked room combinations list;
selectively disassociate each room identifier associated with a linked room combination identifier associated with a reservation request from the room availability indicator associated therewith based at least in part on the plurality of requested reservation parameters;
wherein the system is configured to receive a reservation request associated with a collective group of linked hotel rooms and accommodate the reservation request by booking a linked room combination associated therewith.
